(19) United States
(12) Patent Application Publication
(10) Pub. No.: US 2024/0285371 A1
(43) Pub. Date: Aug. 29, 2024

(54) DENTAL SYSTEM AND DENTAL DELIVERY SYSTEM

(71) Applicant: Dental Components LLC, Newberg, OR (US)

(72) Inventors: Austin E. UNSWORTH, Fort Mill, SC (US); Jason SPENCER, Fort Mill, SC (US)

(21) Appl. No.: 18/584,616

(22) Filed: Feb. 22, 2024

Related U.S. Application Data
(60) Provisional application No. 63/486,554, filed on Feb. 23, 2023.

(51) Int. Cl. A61C 1/00; A61C 1/08; A61C 8/00

(52) U.S. Cl. CPC A61C 1/003; A61C 1/082; A61C 8/0089

(57) ABSTRACT

Various devices, assemblies, components, systems, and methods are provided relating to a delivery system, a connection plate, and an electrical connection system. An example delivery system may include a mount, a movement arm, a delivery portion, and a connection arm. The movement arm may be rotationally connected to the mount at a first connection point of the movement arm and may rotate relative to the mount about a first axis of rotation. The connection arm may be rotationally connected to the movement arm at a second connection point of the movement arm to rotate relative to the movement arm about a second axis of rotation. The movement arm and the connection arm may each be configured to be disposed at least a predetermined minimum height or greater above a ground level at a location of the second axis.

### CROSS-REFERENCE TO RELATED APPLICATIONS

This application claims the benefit of U.S. Provisional Application No. 63/486,554 filed on Feb. 23, 2023, the contents of which are hereby incorporated by reference in their entirety.

### BACKGROUND

Medical practitioners, such as dentists, require numerous tools and utilities (e.g., electricity, water, air, vacuum, etc.) to be close at hand for patient procedures. Dental delivery systems, encompassing several possible form factors, may be used by dentists and other practitioners to position these tools and utilities for efficient access and ease of use. Such delivery systems may include movable portions that support the tools and facilitate positioning the tools close to the patient and/or practitioner. The movable portions may be connected to stationary points, such as the patient chair or an adjacent structure for supporting the movable portions.

Applicant has identified many deficiencies and problems associated with existing dental delivery systems and associated methods, systems, and apparatuses. Through applied effort, ingenuity, and innovation, these identified deficiencies and problems have been solved by developing solutions that are in accordance with the embodiments of the present disclosure, examples of which are described in detail herein.

### BRIEF SUMMARY

Various embodiments of the present disclosure may include a delivery system. In some embodiments, a delivery system may include a mount, a movement arm, a delivery portion, and a connection arm. The movement arm may be rotationally connected to the mount at a first connection point of the movement arm. The movement arm may be configured to rotate relative to the mount about a first axis of rotation. The connection arm may be rotationally connected to the movement arm at a second connection point of the movement arm different than the first connection point. The connection arm may be configured to rotate relative to the movement arm about a second axis of rotation different than the first axis of rotation. The connection arm may be configured to support the delivery portion and connect the delivery portion to the movement arm. The movement arm and the connection arm may each be configured to be disposed at least a predetermined minimum height or greater above a ground level at a location of the second axis. The predetermined minimum height is greater than a user forefoot clearance height such that the delivery system is configured to allow a user forefoot to be disposed beneath the connection arm and the movement arm at the second axis.

In some embodiments, the delivery portion is configured to rotate relative to the connection arm about a third axis of rotation different than the first axis of rotation and the second axis of rotation. The movement arm and the connection arm may each be configured to be disposed at least the predetermined minimum height or greater above the ground level at a location of the first axis.

In some embodiments, the delivery system may include a connection plate disposed between the connection arm and the delivery portion. The connection plate may be configured to support the delivery portion at an upper side thereof. The connection plate may be configured to be supported by the connection arm at a lower side thereof, and the connection plate may further define at least one connector configured to engage a detachable bottle and/or a tool arm.

In some embodiments, a horizontal extent of the movement arm is less than a horizontal extent of the connection arm. In some embodiments, at least a portion of each of the movement arm, the mount, and the connection arm may intersect a common horizontal plane. The movement arm and the connection arm may each configured to be disposed a predetermined maximum height or less above a ground level at the location of the second axis. The predetermined maximum height may be greater than the predetermined minimum height and less than a user knee clearance height, such that the delivery system is configured to allow a user knee to be disposed above the connection arm and the movement arm at the second axis. In some instances, an entirety of the movement arm is disposed below the user knee clearance height. Each portion of the movement arm and the connection arm not disposed vertically beneath the delivery portion may be disposed below the user knee clearance height.

In some embodiments, the movement arm defines a cavity configured to receive at least a portion of a cable and/or conduit. The movement arm may be open along a lower side of the cavity such that the portion of the cable and/or the conduit is configured to be inserted into the cavity, and the mount may define an opening configured to receive at least a second portion of the cable and/or the conduit.

In some instances, the mount may include a pivot portion integral with a mounting plate or configured to attach directly or indirectly to a mounting plate. The pivot portion may be configured to engage the movement arm and the mounting plate may be configured to engage a cabinet or ground.

In some embodiments, the connection arm defines a vertical section at a distal end thereof, and an upper surface of the connection arm may be continuously curved in a vertical plane between the second connection point and the vertical section. In some embodiments, the movement arm and the connection arm may be configured to allow the delivery portion to translate horizontally along an axis without rotating relative to the mount.

In some embodiments of the present disclosure, a dental system may be provided. The dental system may include a delivery system and a storage system. In some embodiments, the storage system may include at least one cabinet and a mount. The mount of the delivery system may be attached to the at least one cabinet or to ground at least partially beneath the at least one cabinet. At least a portion of the mount may be disposed above a lowermost edge of at least one cabinet door of the cabinet. In some embodiments, the storage system may include an electrical connection system disposed above the at least one cabinet. The electrical connection system may define a channel therein, a charging door, and an electrical outlet. The charging door may be connected to the electrical connection system via a hinge. The charging door may rotate about the hinge to allow the charging door to rotate from a closed configuration to an open configuration relative to a second portion of electrical connection system. The electrical outlet may be disposed behind the charging door in an instance in which the charging door is in the closed configuration. The electrical outlet may be configured to be angled at a non-perpendicular and non-parallel angle relative to a surface of the at least one cabinet door of the at least one cabinet in a closed configuration. The charging door may include a slot configured to allow for electrical cables to pass through the slot and behind or into the at least one cabinet in an instance in which the charging door is in the closed configuration.

In some embodiments, the electrical connection system is disposed on a countertop above the at least one cabinet.

Some embodiments of the present disclosure may include a delivery portion assembly. The delivery portion assembly may include a delivery portion and a connection plate. The connection plate may include a body with an upper side and a lower side. The body may define a tool arm connector, a detachable bottle connector, a delivery portion connector at the upper side configured to engage a delivery portion of the delivery system, and a connection arm connector at the lower side configured to engage a connection arm of the delivery system. In some embodiments, the delivery portion may be configured to rotate relative to the connection plate.

In some embodiments, the body of the connection plate may further include a protrusion on the delivery portion connector or a connector of the delivery portion, and the protrusion may be configured to limit rotation of the delivery portion relative to the connection plate.

Some embodiments of the present disclosure may include an assembly including a delivery portion assembly, a mount, a movement arm, and a connection arm. The movement arm may be rotationally connected to the mount at a first connection point of the movement arm. The movement arm may rotate relative to the mount about a first axis of rotation. The connection arm may be rotationally connected to the movement arm at a second connection point of the movement arm different than the first connection point. The connection arm may be configured to rotate relative to the movement arm about a second axis of rotation different than the first axis of rotation. The connection arm may support the delivery portion and connect the delivery portion to the movement arm. The movement arm and the connection arm may each be configured to be disposed at least a predetermined minimum height or greater above a ground level at a location of the second axis. The predetermined minimum height may be greater than a user forefoot clearance height such that the delivery system is configured to allow a user forefoot to be disposed beneath the connection arm and the movement arm at the second axis.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the disclosure in general terms, reference will now be made to the accompanying drawings, which are not necessarily drawn to scale, and wherein:

FIG. 1A illustrates a perspective view of an example dental system in accordance with various embodiments of the present disclosure;

FIG. 1B illustrates a perspective view of an example storage system in accordance with various embodiments of the present disclosure;

FIG. 1C illustrates a perspective view of an example connection point in accordance with various embodiments of the present disclosure;

FIG. 2A illustrates a perspective view of an example delivery system in accordance with various embodiments of the present disclosure;

FIG. 2B illustrates a top view of an exemplary movement of a delivery system in accordance with various embodiments of the present disclosure;

FIG. 2C illustrates a perspective view of an example delivery system in accordance with various embodiments of the present disclosure;

FIG. 2D illustrates a perspective view of an example delivery portion of the delivery system in accordance with various embodiments of the present disclosure;

FIG. 3A illustrates a perspective view of a movement arm and stationary mount in accordance with various embodiments of the present disclosure;

FIG. 3B illustrates a bottom perspective view of a movement arm and stationary mount in accordance with various embodiments of the present disclosure;

FIG. 3C illustrates a top perspective view of a movement arm and stationary mount in accordance with various embodiments of the present disclosure;

FIG. 3D illustrates an isolated perspective view of a movement arm in accordance with various embodiments of the present disclosure;

FIG. 3E illustrates a movement arm in a first position in accordance with various embodiments of the present disclosure;

FIG. 3F illustrates a movement arm in a second position in accordance with various embodiments of the present disclosure;

FIG. 3G illustrates a movement arm in a third position in accordance with various embodiments of the present disclosure;

FIG. 3H illustrates a lower perspective view of a connection arm in accordance with various embodiments of the present disclosure;

FIG. 4A illustrates a perspective view of a portion of a delivery system including an example connection plate in accordance with various embodiments of the present disclosure;

FIG. 4B illustrates a top perspective view of an example connection plate in accordance with various embodiments of the present disclosure;

FIG. 4C illustrates a bottom perspective view of an example connection plate in accordance with various embodiments of the present disclosure;

FIG. 4D illustrates a perspective view of a portion of a delivery system including an example connection plate with an arm in accordance with various embodiments of the present disclosure;

FIG. 4E illustrates a partial cross-sectional view of a portion of a delivery system in accordance with various embodiments of the present disclosure;

FIG. 4F illustrates a perspective view of a support member in accordance with various embodiments of the present disclosure;

FIG. 5A illustrates a perspective view of an example electrical connection system in accordance with various embodiments of the present disclosure;

FIG. 5B illustrates a detailed view of an example electrical connection system of FIG. 5A, wherein the detail view is taken along detail circle 5B of FIG. 5A;

FIG. 5C illustrates a perspective view of an example channel in accordance with various embodiments of the present disclosure;

FIG. 5D illustrates a cross-sectional perspective view of an example gap associated with a wall in accordance with various embodiments of the present disclosure;

FIG. 6 illustrates a perspective view of a portion of a dental system in accordance with various embodiments of the present disclosure;

FIG. 7A illustrates a perspective view of a portion of a dental system in accordance with various embodiments of the present disclosure;

FIG. 7B illustrates a bottom perspective view of a stationary mount and portion of a cabinet in accordance with various embodiments of the present disclosure;

FIG. 7C illustrates a bottom perspective view of a portion of a delivery system in accordance with various embodiments of the present disclosure;

FIGS. 7D-7E illustrate isolated views of a movement arm in accordance with various embodiments of the present disclosure;

FIG. 7F illustrates a top perspective view of a movement arm in accordance with various embodiments of the present disclosure; and

FIG. 8 illustrates a schematic representation of an example controller in accordance with various embodiments of the present disclosure.

### DETAILED DESCRIPTION

Embodiments of the present disclosure will be described more fully hereinafter with reference to the accompanying drawings, in which some, but not all embodiments are shown. Indeed, instances of the present disclosure may be embodied in many different forms and should not be construed as limited to the embodiments set forth herein; rather, these embodiments are provided so that this disclosure will satisfy applicable legal requirements. Like numbers refer to like elements throughout.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment. Moreover, the various features disclosed in the present application, including portions or combinations thereof, may be combined with and/or isolated from the depicted embodiments without departing from the scope of the disclosure. Similarly, features depicted as being part of a particular embodiment may be combined with and/or substituted for features of the various other embodiments of the present disclosure. As used herein, the terms “example,” “exemplary,” and the like are used to “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

The figures are provided to illustrate some examples of the present disclosure. The figures are not to limit the scope of the present disclosure or the appended claims. Aspects of the example embodiments are described below with reference to example applications, use cases, and operating circumstances for illustration. Specific details, relationships, and methods are set forth to provide a full understanding of the example embodiments and are not to limit the scope of the present disclosure or the appended claims. One of ordinary skill in the art will recognize, in light of the present disclosure, that the various example embodiments can be practiced without one or more specific features and/or with other features.

The present disclosure includes embodiments of a delivery system, including various components thereof and apparatuses, systems, and methods associated therewith. Delivery systems may be configured to facilitate positioning and delivery of the tools and utilities used by a practitioner during a procedure (e.g., a dental procedure). In some instances, a dental delivery system is provided that is configured to attach to or adjacent a cabinet. Cabinet-based dental delivery systems may facilitate delivery of one or more utilities (e.g., electricity, water, air, vacuum, etc.) from the cabinet or adjacent to the cabinet to minimize the visibility and hazard of at least some cords, conduits, and other articles by containing them within a protected space.

In some instances, a practitioner may sit on a chair adjacent to the delivery system and patient chair. Based on the practitioner and patient's positioning, the various tools may need to be accessed from several locations without interfering with the practitioner's access to the patient. Embodiments of the present disclosure include a stationary mount configured to attach to a stationary structure (e.g., the ground, the cabinet, a wall, the chair, or any other structure in the practitioner's environment) and a movable assembly connected to the stationary mount to facilitate the tool positioning and delivery of the utilities.

In some instances, the movable assembly may include a delivery portion, one or more arms, and/or a detachable bottle connector. The movable assembly may further include a connection plate configured to engage the delivery portion, one or more arms, and/or a detachable bottle and to facilitate the movement thereof, positioning thereof, and/or routing of cords and conduits thereto and therefrom. The connection plate, and thereby the delivery portion, one or more arms, and/or detachable bottle may engage and be supported by one or more support arms (e.g., a movement arm and/or connection arm as discussed herein) connected, directly or indirectly, to the mount. In some embodiments, the connection plate is rotationally connected to one or more of the delivery portion, arm(s), support arm(s), and/or the detachable bottle to allow at least some rotation therebetween for positioning the respective components relative to the practitioner at least partially independently of the position of the support arm(s) (e.g., range or angle limited rotation, full rotation, etc.). For example, the connection between the delivery portion and the connection plate may include one or more protrusions to limit the range of motion of the delivery portion to 360 degrees or less (e.g., to prevent the cords and/or conduits from becoming twisted due to over rotation). In some embodiments, the connection plate may be rotationally locked with at least one or more of the delivery portion, arm(s), support arm(s), and/or the detachable bottle. In some instances, an extendable piston may support the connection plate to adjust the height of the delivery portion, one or more arms, and/or the detachable bottle.

In some instances, the one or more support arms may include a movement arm engaging, directly or indirectly, the mount and a connection arm engaging, directly or indirectly, the movement arm and the connection plate. In cabinet embodiments, the mount may be at or adjacent to a portion of the cabinet, such that the delivery system may be stored against the cabinet. The movement arm may provide a short connecting arm between the mount and the connection arm to facilitate flush or substantially positioning of the delivery system against the cabinet and/or to facilitate more movement options for the delivery portion and other tools atop the connection arm. For example, in some embodiments, the combination of a first rotatable connection between the mount and movement arm and a second rotatable connection between the movement arm and the connection arm may facilitate linear movement of the delivery portion and/or other tools. In some embodiments, the ability of the delivery portion and/or other tools to rotate (e.g., relative to or along with the connection plate) may further facilitate linear translational movement of the delivery portion and/or other tools relative to the mount. For example, embodiments of the delivery system as provided herein allows the user to move portions of the delivery system translationally and/or in rotation.

In some instances, a seated practitioner may need foot and/or knee clearance to move themselves and/or the delivery system around the patient. Some embodiments of the present disclosure are configured to improve the foot and knee space available to the user. For example, in some instances, at least a portion of the connection arm and/or movement arm may be disposed greater than a user forefoot height above the ground level so that the user's forefoot may extend beneath the portion of the support arm(s). In some instances, at least a portion of the connection arm and/or movement arm may additionally or alternatively be below a maximum height (e.g., beneath user knee height or a fraction thereof configured to facilitate free knee movement). In some embodiments, at least a portion of the movement arm and/or connection arm may be disposed at approximately ankle or lower shin height to allow the user maximum foot and knee movement. For example, in some embodiments, a portion of the connection arm and the movement arm not disposed beneath the delivery portion may be in one or more of the aforementioned positions (e.g., above the user forefoot height and/or below the user knee height). In some embodiments, the movement arm may be generally horizontal (e.g., at or approximately the same height between both connection points, or a portion thereof, such as an upper surface). In some embodiments, the connection arm may be curved from an approximately horizontal position to an approximately vertical position. The curve may be abrupt (e.g., occurring over a short or right-angle distance) or continuous from at or proximate the connection with the movement arm to the vertical portion of the arm. In some instances, various components described herein may include cavities for cords and/or conduits to run therethrough. The electrical connection system and/or various other utilities as provided herein allow the user to hide the various points and store cord and/or conduit within one or more cavities within the cabinet, wall, and/or other portions of the delivery system.

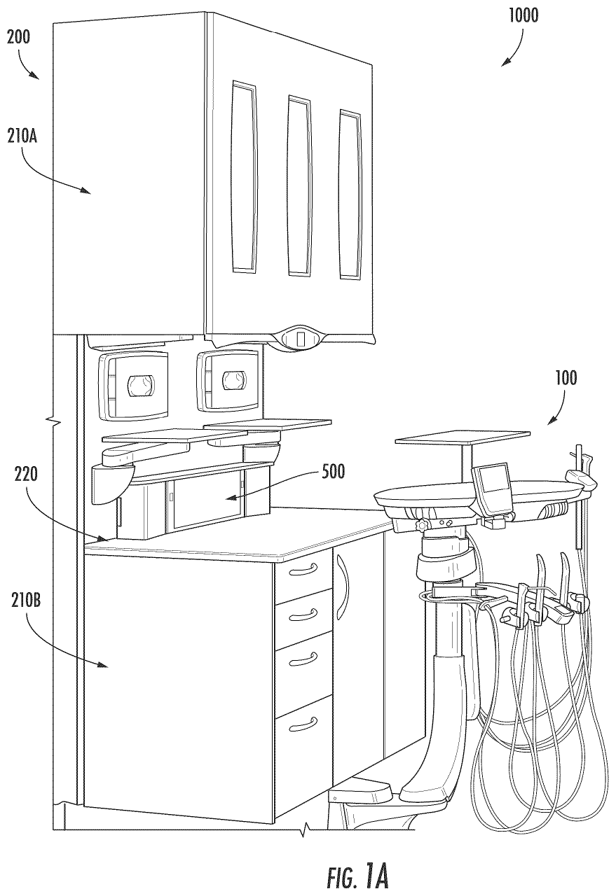

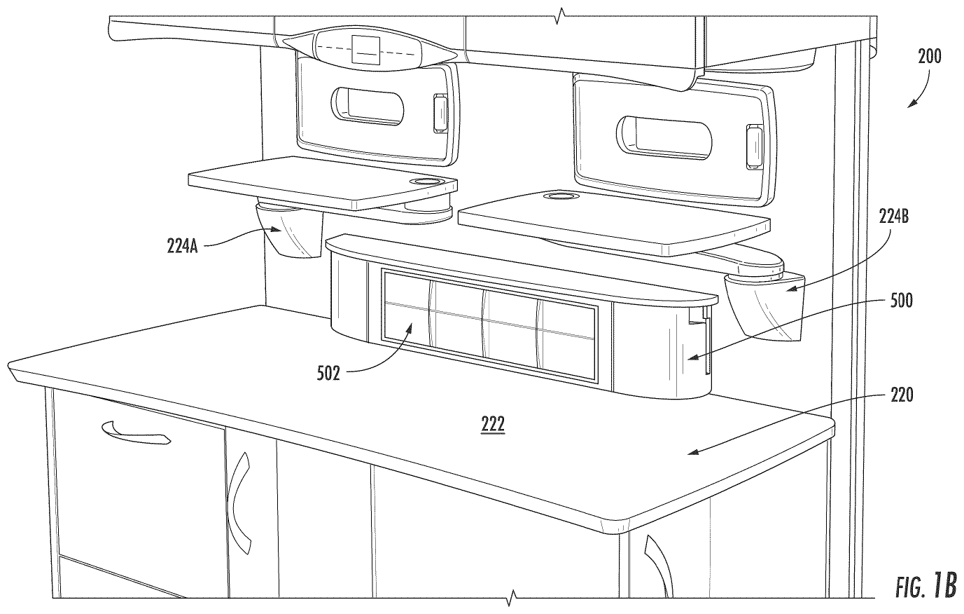

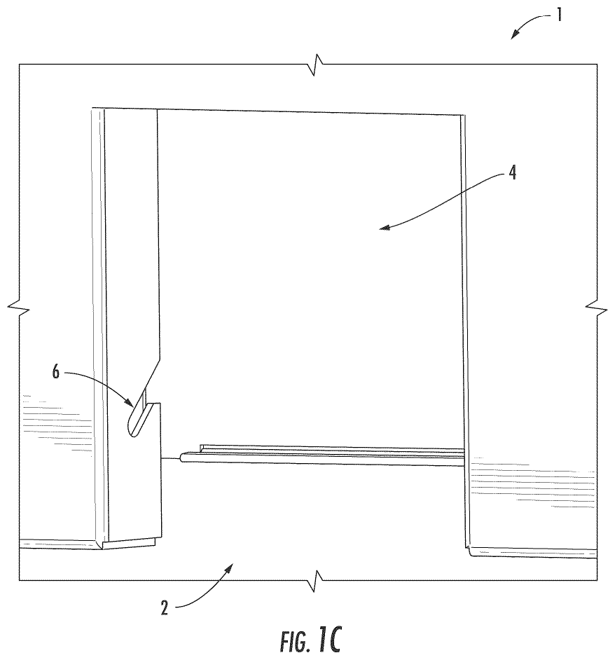

FIG. 1A illustrates an embodiment of an example system 1000 in accordance with various embodiments of the present disclosure. The system 1000 may generally comprise a delivery system 100 and a storage system 200 (e.g., a cabinet), which storage system 200 the delivery system 100 may be at least partially secured to. Further, the delivery system 100 may be secured at least partially to a stationary structure, such as the ground and/or to a portion of the storage system 200. The storage system 200 itself may be secured to a wall and/or the ground. The delivery system 100 may be secured to the storage system 200 and/or the ground using a variety of known means including permanent or temporary means, including adhesive, welding, threaded fasteners and threaded connectors such as one or more nuts and bolts, screws, and/or any other threaded fasteners and/or threaded connectors that may be apparent to one of ordinary skill in the art. In various embodiments, the storage system 200 may comprise a top storage portion 210A, a bottom storage portion 210B, and/or a counter portion 220, wherein the delivery system 100 may secure at least partially to the bottom storage portion 210B. In some embodiments, the delivery system may be termed a “rear delivery system” in an instance in which the storage system 200 and connection of the

In some embodiments, an electrical connection system 500 may be provided in association with the storage system 200 to facilitate one or more electrical connections for the system 100. FIG. 1B illustrates a perspective view of counter portion 220 of the storage system 200 in accordance with various embodiments of the present disclosure. The counter portion 220 includes a flat surface (e.g., counter surface) 222 that may support the electrical connection system 500, and the flat surface 222 may extend the entire width of the storage system. The flat surface 222 may smoothly transition from one flat surface to an additional flat surface in an instance, in which, more than one storage systems are connected together (e.g., for multiple adjacent storage systems). In some embodiments, the flat surface 222 may comprise a curved front edge, wherein the curved front edge may allow a user better access to the storage system. In various embodiments, the flat surface 222 may extend beyond the width of the top storage portion 210A and/or bottom storage portion 210B of the storage system. In some embodiments, the electrical connection system 500 may secure to the flat surface 222 at least partially. In some embodiments, the electrical connection system 500 may be constructed as a part of the flat surface 222. In various embodiments, the flat surface 222 may support, at least partially, the electrical connection system 500. The electrical connection system 500 may extend the entire width of the flat surface 222, in some embodiments. In other embodiments, the electrical connection system 500 may extend only a portion of the width of the flat surface 222. In various embodiments, the electrical connection system 500 may comprise at least one bin 502 configured to hold one or more items (e.g., accessories, gloves, disposable articles, etc.) for the practitioner. The bin may move from a closed configuration to an open configuration via a hinge. The hinge may be located on the bottom of the bin 502, such that the bin's axis of rotation is disposed near the flat surface 222.

In some embodiments, the storage system 200 may further comprise one or more connection points 224A, 224B (collectively “224”) that are disposed vertically above the flat surface 222 itself, wherein the connection points 224 may be secured to a backsplash portion of the top storage portion 210A. The connection points 224 may connect to and support one or more shelves above the counter portion 220 of the storage system. The connection points may each connect to one shelf individually (e.g., a first shelf connects to a first connection point 224A, and a second shelf connects to a second connection point 224B, as depicted in FIG. 1B). In some embodiments, a single shelf may be connected to both the first connection point 224A and the second connection point 224B, wherein the single shelf extends at least the entire distance between the connection points.

FIG. 1C illustrates a perspective view of a connection point 1 of a storage system 200 in accordance with various embodiments of the present disclosure. The storage system may comprise an opening 4 configured to receive a portion of the delivery system (e.g., delivery system 100 shown in FIGS. 1A-1B). The opening 4 may be defined at least partially by a stationary structure such as the ground 2 and/or a portion of the storage system. The opening 4 may further comprise a connection portion 6 (e.g., a slot). The connection portion 6 may be configured to engage at least partially with the delivery system for facilitating securing the delivery portion to the storage system.

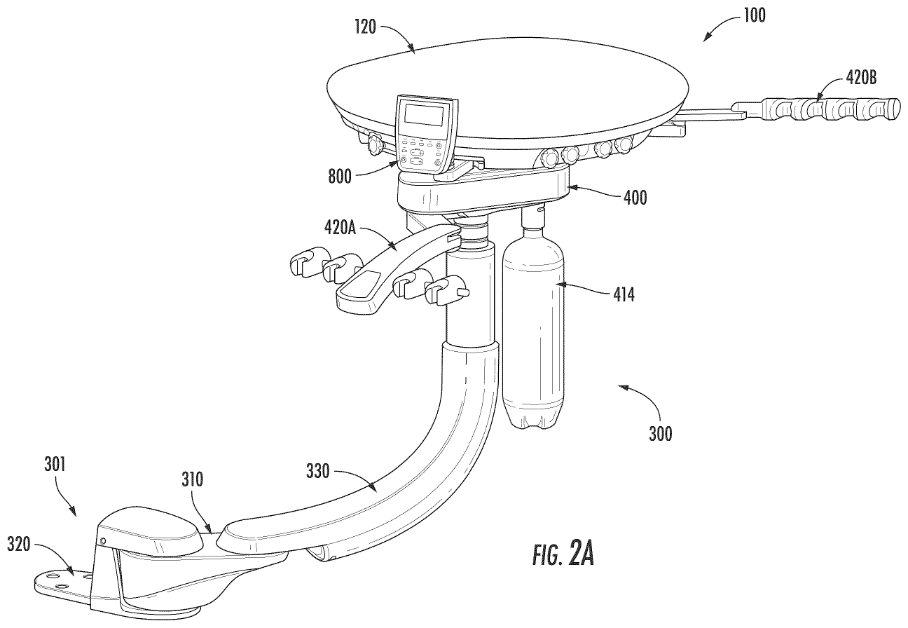

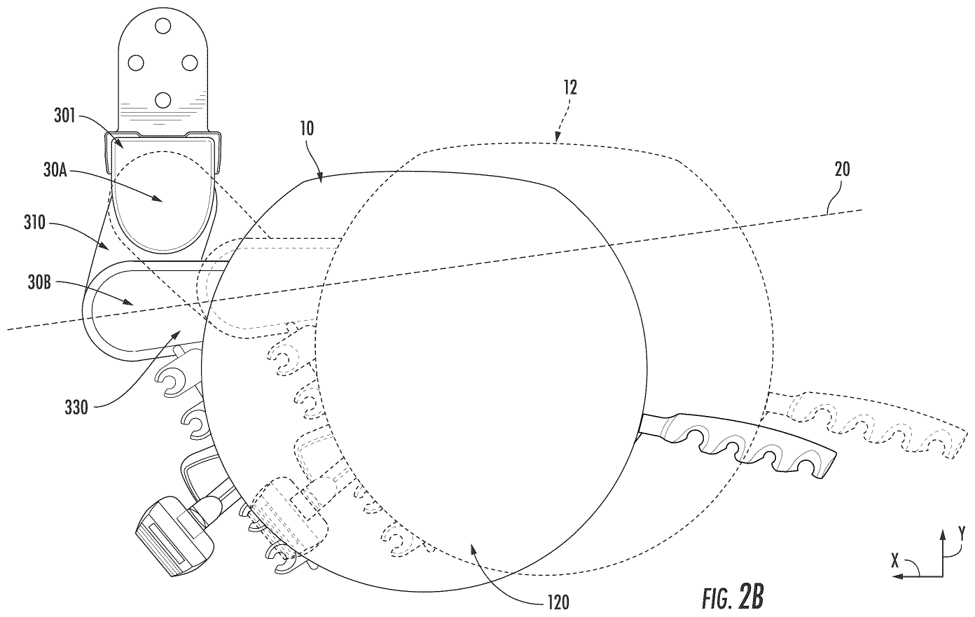

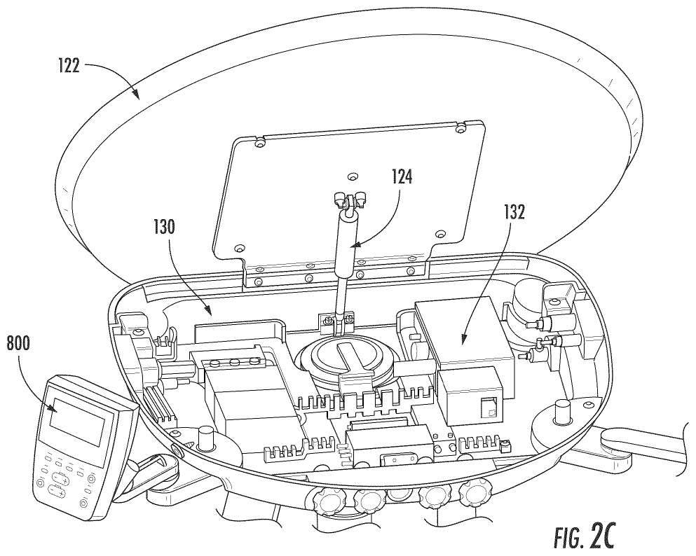

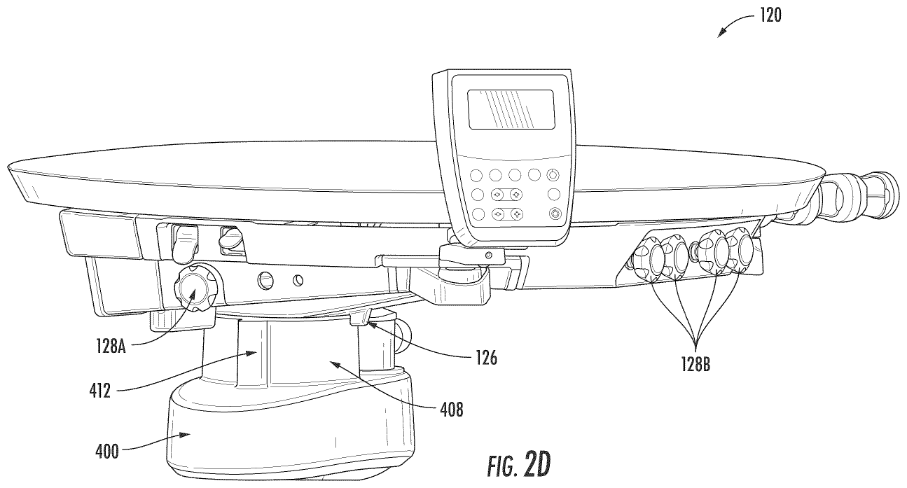

FIG. 2A illustrates a perspective view of a delivery system 100 in accordance with various embodiments of the present disclosure. The delivery system 100 may assist with handling and/or housing components for dental procedures, for example, water supplies, air supplies, tools, associated cords and conduits, etc. while being able to be adjusted by a user to their liking. In the depicted embodiment, the delivery system 100 includes a stationary mount 301 and movable assembly 300. The depicted movable assembly 300 includes a delivery portion 120 connected to a connection plate 400, with the connection plate 400 engaging a connection arm 330, which engages the stationary mount 301 via a movement arm 310. In various embodiments, the movable assembly 300 comprises a movement arm 310 and a connection arm 330 configured to adjust the position of the connection plate 400 relative to the stationary mount 301. The stationary mount 301 may define a hinge for the movement arm 310 at a first connection point and may include a mounting plate 320 for affixing the stationary mount to a stationary structure (e.g., the ground and/or storage system). The connection arm 330 may rotationally secure to the movement arm 310 at a second connection point, such that the connection arm 330 moves relative to the movement arm 310 and the stationary mount 301 via the connection point between the movement arm 310 and the connection arm 330. The movement arm 310 may move along one or more axes relative to a first connection point and/or a delivery portion connected to the connection arm may move along one or more axis relative to a second connection point either simultaneously or individually. The movement arm 310 may be moved in free rotation relative to the connection arm 330 at least between left and right extreme contact points (e.g., points where the connection arm 330 contacts the hinge portion of the stationary mount 301). In some embodiments, at least a portion of each of the movement arm 310, the stationary mount 301, and the connection arm 330 intersects a common horizontal plane. In some embodiments, a horizontal extend of the movement arm 310 may be less than a horizontal extent of the connector arm 330.

The connection arm 330 and/or movement arm 310 may be moved by a force applied to the delivery portion 120. In various embodiments, the mounting plate 320 may secure the delivery system 100 at least partially to the stationary structure (e.g., ground and/or the storage system 200 as shown in FIG. 1A). In some embodiments, the delivery portion 120 may be used to rotate the connection arm 330 relative to the connection point between the movement arm 310 and the connection arm 330. The delivery portion may be further configured to move the movement arm 310 and the connection arm 330 relative to the connection point between the movement arm 310 and the stationary mount 301.

In some embodiments, the movement arm 310 may provide an additional function of facilitating ambidextrous usage of the delivery system 100 by permitting the delivery portion 120 to shift side to side relative to the stationary mount 301 (e.g., by rotating the movement arm through its range of motion). In such instances, the movement arm 310 may allow the connection arm 330 and downstream components (e.g., the delivery portion, delivery bottle, etc.) to be in generally the same orientation in multiple horizontal positions (e.g., for a right or left handed user). For example, in some embodiments, a maximum distance between the left-most extreme and right-most extreme positions of the movement arm is approximately 6 inches or more. In some embodiments, the maximum distance may be dependent upon the length and/or range of motion of the movement arm.

With further reference to FIG. 2A, in various embodiments, the movement arm 310 and/or the connection arm 330 may comprise at least a portion that is curved (e.g., a radius scalloped shape). For example, in the depicted embodiment, the connection arm 330 defines an upward curve between its connection point with the movement arm 310 and a vertical portion at a distal end of the connection arm. The connection arm 330 is further rounded and/or chamfered in a direction perpendicular to its length such that the connection arm is less likely to snag on a practitioner's clothing and/or on one or more conduits, cables, and other components that may be in the dental theater. As used herein, “cable” and similar terminology may refer to components configured to facilitate transmission of electrical signals and energy (e.g., power cables, data cables, etc.), and as used herein “conduit” and similar terminology may refer to components configured to facilitate transmission of physical material in whatever form (e.g., vacuum conduit, air conduit, water conduit, etc.). In some embodiments, the movement arm 310 and/or the connection arm 330 may disposed above the stationary structure (e.g., not contacting the ground), such that a user may be able to slide at least one foot or a portion thereof (e.g., the user's forefoot) under the movement arm 310 and/or the connection arm 330.

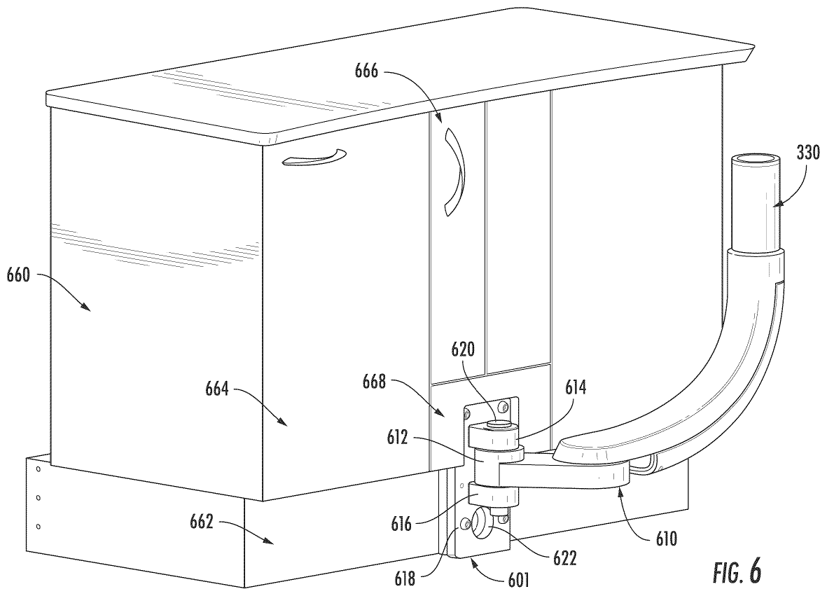

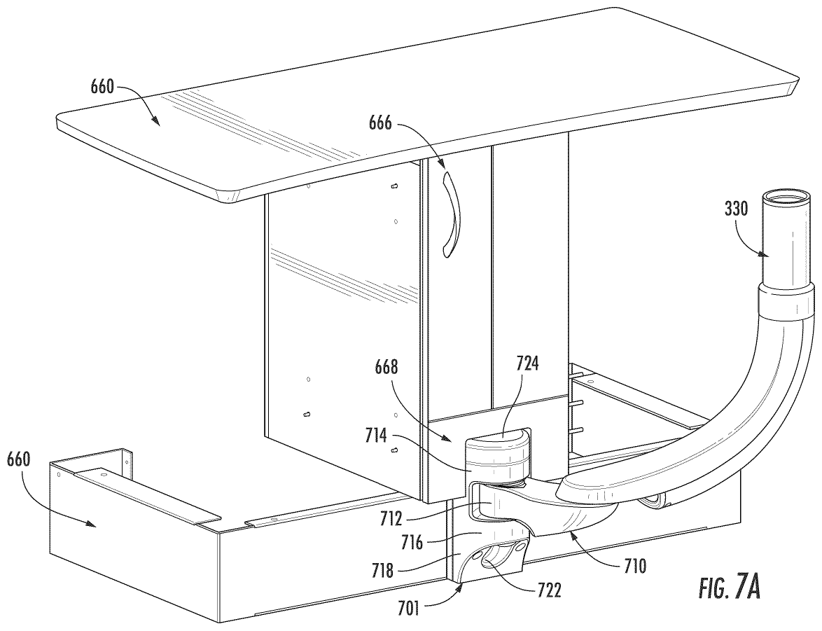

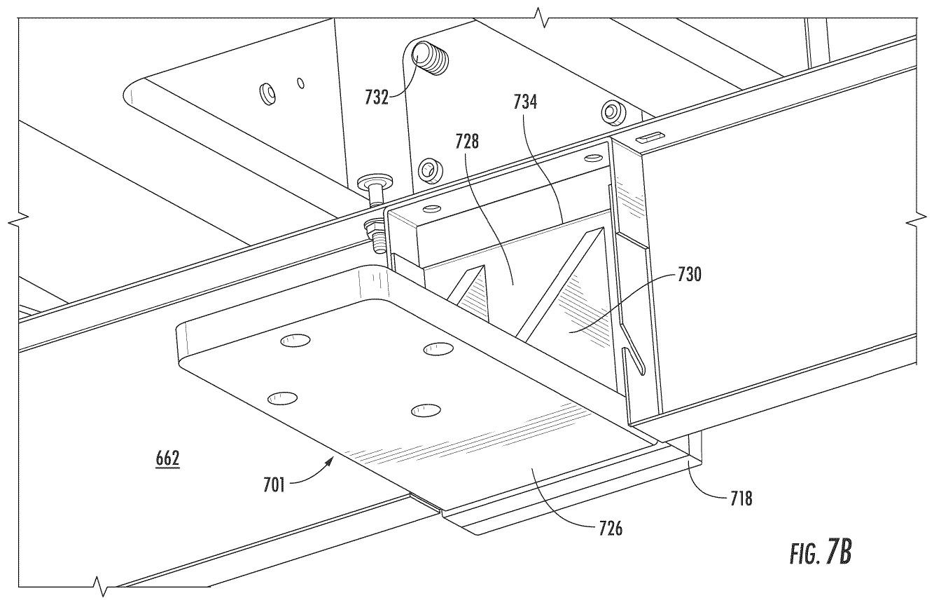

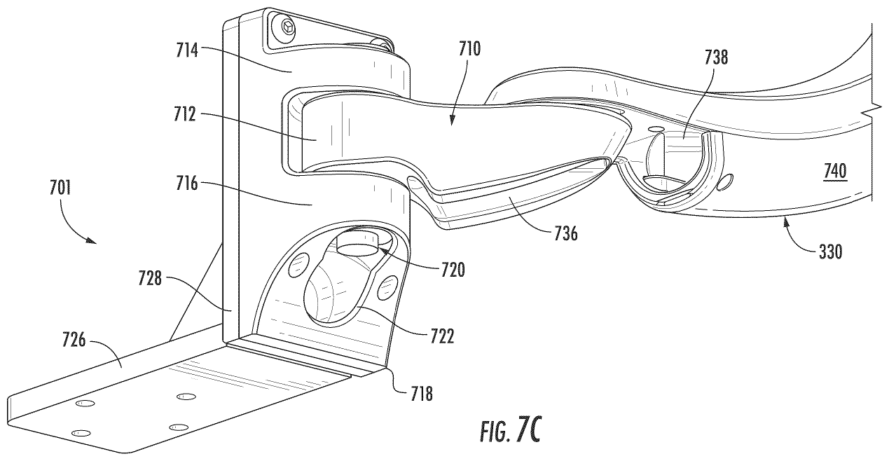

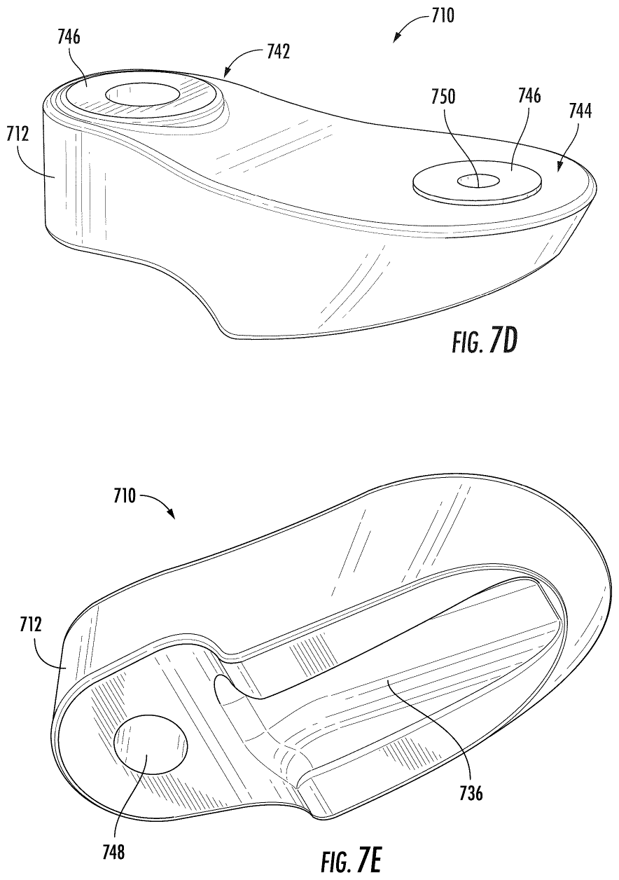

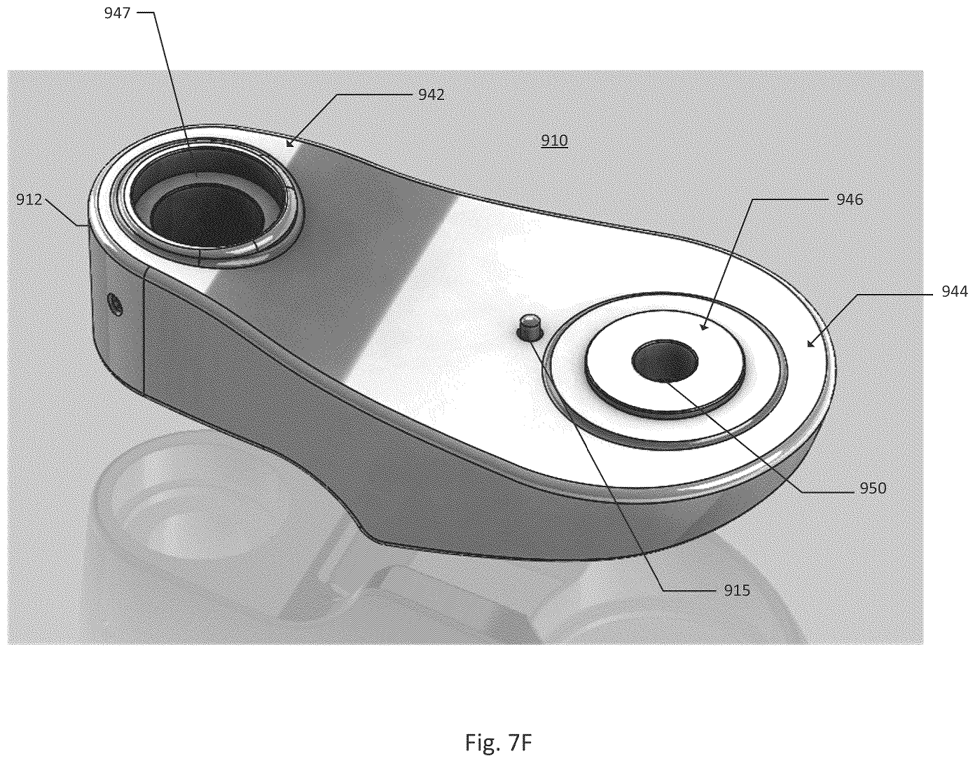

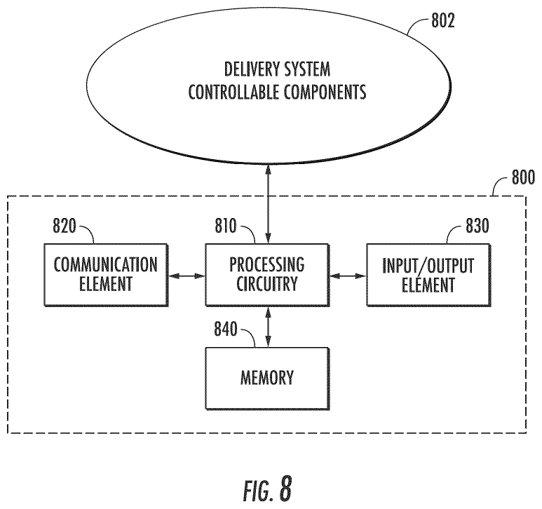

In various embodiments, the positioning of the stationary mount 701 and movable assembly may be configured to improve practitioner mobility and access to the various tools and other components on the delivery system 100. While examples are given with reference to the embodiment shown in FIGS. 1-4F, the various dimensions and relationships described herein may be applicable to any embodiment. For example, in the embodiment depicted in FIG. 2A, a portion of the connection arm 330 and a portion of the movement arm 310 are disposed above a predetermined minimum height and below a predetermined maximum height wherein the predetermined minimum height is greater than a user forefoot clearance height such that the delivery system 100 is configured to allow a user forefoot to be disposed beneath the portion of the connection arm 330 and the portion of the movement arm 310. For example, the axis about which the connection arm and movement arm are joined may be above the predetermined minimum height. In some embodiments, the predetermined minimum height may extend the full length of the movement arm 310 (e.g., as shown in FIGS. 6-7E), half-way along the movement arm 310, or any other increment of the movement arm. In some embodiments, the entire connection arm 330 and all components downstream of the connection arm (e.g., the delivery portion, detachable bottle, etc.) may be above the predetermined minimum height. For example, the predetermined minimum height may be at least a user forefoot clearance height, which height may be sufficient to allow at least a user's forefoot to rest on the ground beneath the respective component. In some embodiments, the predetermined minimum height and the user forefoot clearance height may be at least 2 inches or greater in height. In some embodiments, the predetermined minimum height and the user forefoot clearance height may be at least 3 inches or greater in height. In some embodiments, the predetermined minimum height and the user forefoot clearance height may be at least 4 inches or greater in height. In some embodiments, the predetermined minimum height and the user forefoot clearance height may be at least 5 inches or greater in height. In some embodiments, the predetermined minimum height and the user forefoot clearance height may be at least 6 inches or greater in height. In some embodiments, the predetermined minimum height and the user forefoot clearance height may be at least 7 inches or greater in height. In some embodiments, the predetermined minimum height and the user forefoot clearance height may be at least 8 inches or greater in height. In some embodiments, the predetermined minimum height and the user forefoot clearance height may be at least as tall as the height of a toe kick of the base of a cabinet.

In some embodiments, the predetermined maximum height may be a user knee clearance height, such that a seated user may position their knees above the respective portion of the connection arm 330 and/or the movement arm 310. For example, in some embodiments, the user knee clearance height may be 24 inches or lower. In some embodiments, the predetermined maximum height and the user knee clearance height may be 22 inches or lower. In some embodiments, the predetermined maximum height and the user knee clearance height may be 20 inches or lower. In some embodiments, the predetermined maximum height and the user knee clearance height may be 18 inches or lower. In some embodiments, the predetermined maximum height and the user knee clearance height may be 16 inches or lower. In some embodiments, the predetermined maximum height and the user knee clearance height may be 14 inches or lower. In some embodiments, the predetermined maximum height and the user knee clearance height may be 12 inches or lower. In some embodiments, the entire movement arm 310 and the stationary support 301 may be disposed beneath the predetermined maximum height. In some embodiments, the connection arm 330 at the second connection point with the movement arm 310 may be disposed beneath the predetermined maximum height. In some embodiments, each portion of the connection arm 330 not disposed vertically beneath the delivery portion 120, connection plate 400, and/or arm(s) 420 may be beneath the predetermined maximum height. In some embodiments, an empty space defined above the connection arm 330 and/or 310 for the user's knee may begin at least 12 inches or greater above the ground. In some embodiments, the empty space defined above the connection arm 330 and/or 310 for the user's knee may begin at least 18 inches or greater above the ground. In some embodiments, the empty space defined above the connection arm 330 and/or 310 for the user's knee may begin at least 24 inches or greater above the ground. In some embodiments, the empty space defined above the connection arm 330 and/or 310 for the user's knee may be defined at least between 18 and 24 inches above the ground.

In some embodiments, the portion of the movement arm 310 and the portion of the connection arm 330 may be both above the predetermined minimum height and below the predetermined maximum height to allow the user (e.g., practitioner) foot and knee clearance when using the delivery system. For example, the portion of the movement arm 310 and the portion of the connection arm 330 may be disposed within an ankle-to-shin height range that permits the user freedom of knee and foot movement.

In various embodiments, the delivery portion 120 secures (whether fixedly or movably) to the connection arm 330 via a connection plate 400. The connection between the delivery portion 120 and the connection plate 400 may allow the delivery portion 120 to rotate relative to the connection plate 400 while the connection plate 400 remains stationary relative to the connection arm 330. In some embodiments, the connection plate 400 may rotate relative to the connection arm 330 in addition to or instead of the delivery portion 120 rotating relative to the connection plate 400. In various embodiments, the connection plate 400 secures to the connection arm 330 at side disposed opposite of the connection between the connection plate 400 and the delivery portion 120 (e.g., a top side of the connection plate includes a connector for engaging the delivery portion and a bottom side of the connection plate includes a connector for engaging the connection arm in the depicted embodiment). The connection between the connection plate 400 and the connection arm 330 may be disposed at a vertically greater distance from the stationary mount 301 and associated portion of the stationary structure (e.g., ground) than the connection point between the movement arm 310 and the connection arm 330. In various embodiments, delivery portion 120 or another portion of the delivery system may include a controller 800, where the controller 800 may include a processor and/or memory along with computer coded instructions for facilitating electronic control of one or more functions of the delivery portion 120.

With further reference to FIG. 2A, in various embodiments, at least one arm 420A, 420B (collectively “420”) and/or at least one detachable bottle 414 may secure to the connection plate 400 and/or the delivery portion 120. A first arm 420A is shown in the depicted embodiment connected to a first side of the connection plate 400, and a second arm 420B is shown connected to the delivery portion 120 on a laterally opposite side relative to the first arm 420A (at least in the depicted rotational position of the delivery portion). The first arm 420A and the second arm 420B may move independently from each other relative to the connection point of each individual arm with the connection plate 400 and/or delivery portion 120. In some embodiments, a detachable bottle 414 may selectively secure with the connection plate 400. The detachable bottle 414 may be connected to and/or disconnected from the connection plate 400 selectively by a user. In the depicted embodiment, both the first arm 420A and the bottle 414 attach to a bottom side of the connection plate 400. In some embodiments, a collection trap may be disposed on the same side as the bottle to facilitate ease of service of the water system.

FIG. 2B illustrates exemplary movement of an example delivery system 100 in accordance with various embodiments of the present disclosure. In various embodiments, the movement arm 310 and connection arm 330 rotating about their respective connection points (e.g., hinges) in cooperation with one or more rotatable connections supporting the delivery portion 120 may allow the delivery portion 120 to move laterally and translationally along a single, linear first axis 20. For example, in the depicted embodiment, the movement arm 310 may rotate relative to the first connection point 30A while the connection arm 330 moves around the second connection point 30B and the delivery portion 120 moves around its pivot point with the connection plate causing the delivery portion 120 to move along the first axis 20. The delivery portion 120 thereby moves along at least the first axis 20 without rotating and/or pivoting relative to a first connection point 30A between the movement arm and the mounting plate. The delivery system 100 may move laterally from a first position 10 along the first axis 20 to a second position 12. The first position 10 and the second position 12 may be disposed along the same axis, such that the exemplary movement of the delivery system 100 is linear movement. In other embodiments, the distance between the first position 10 and the second position may be defined by more than the length of the movement arm and/or the less than the length of the movement arm.

While the first axis 20 and movement depicted in FIG. 2B is exemplary of a translational movement of the delivery portion 120, the delivery system 100 may move laterally and rotationally in any direction and distance within the maximum arc of the fully extended movement arm 310 and connection arm 300. The connection arm 330 may be rotationally connected to the movement arm, such that the connection arm moves relative to the movement arm and/or simultaneously with the movement arm depending on the direction of force applied to the delivery portion 120 by the user. The multi-hinge movement of the connection arm 330, movement arm 310, and delivery portion 120 allows for the delivery portion 120 to move translationally and/or rotationally within the aforementioned area. The movement arm allows for the delivery system 100 to move laterally and/or rotationally relative to the stationary mount and mounting plate, such that the delivery portion 120 moves about the first connection point 30A, the second connection point 30B, and/or a third connection point between the delivery portion 120 and the connection plate (alternatively, between the connection plate and the connection arm). The first connection point 30A is defined by the connection (e.g., hinge) between the stationary mount 301 and the movement arm 310. Further, the second connection point 30B is defined by the connection (e.g., hinge) of the movement arm 310 with the connection arm 330. In various embodiments, the delivery portion 120 may rotationally move about the first connection point 30A and/or the second connection point 30B simultaneously and/or individually. For example, the rotational movement and additional translational movement allows a user to adjust the delivery system at least partially in a second direction (e.g., in the depicted embodiment, y-direction) to further adjust the delivery system to a desired position.

FIGS. 2C-2D illustrate perspective views of a delivery portion 120 in accordance with various embodiments of the present disclosure. The depicted delivery portion 120 comprises a lid 122 that may move from a closed configuration (e.g., depicted in FIG. 2A) to an open configuration (e.g., depicted in FIG. 2C). The lid 122, while in the closed configuration (e.g., depicted in FIG. 2A) can be used as a working surface to hold items during procedures, to write on, and/or for any other use. The lid 122 moves from the closed configuration to the open configuration with the assistance of one or more movement element(s) 124 rotating the lid 122 about one or more hinges. The movement element 124 may be a spring, a spring-loaded hinge, a piston, a hydraulic hinge, and/or the like. The movement element 124 may be further configured to assist in keeping the lid 122 in the open configuration, such that the user does not have to manually hold the lid 122 open. In various embodiment, the delivery portion 120 further comprises a storage compartment 130 that houses one or more electrical components 132, wherein the storage compartment 130 is defined at least partially by the lid 122 of the delivery portion (e.g., beneath the lowermost surface of the lid 122). The electrical components within the storage compartment 130 may electrically connect to a controller 800 that is secured to a portion of the delivery portion 120, and the controller 800 may able to control one or more functions of the delivery portion 120.

With reference to FIG. 2D, in various embodiments, the delivery portion 120 further comprises a protrusion 126 and/or one or more control knobs 128A, 128B (collectively “128”). In the depicted embodiment, the connection plate 400 may include a delivery portion connector 408 configured to facilitate engagement with the delivery portion 120 (e.g., via a connector, portion of the delivery portion inserting into or around the delivery portion connector 408, or the like). The protrusion 126 of the delivery portion 120 is configured to engage with a corresponding protrusion 412 on the delivery portion connector 408 when the delivery portion 120 is rotating relative to the connection plate 400. The engagement between the two protrusions 126, 412 prevents the delivery portion 120 from completing a full rotation, such that, in the depicted embodiment, one or more electrical cables, one or more conduits, and/or the like connected to the delivery portion may be prevented from becoming twisted and/or broken. In various embodiments, the control knobs 128 may be connected to one or more corresponding electrical components within or associated with the delivery portion 120, such that the control knobs may control specific functions of the delivery system, such as, air, water, suction, etc.

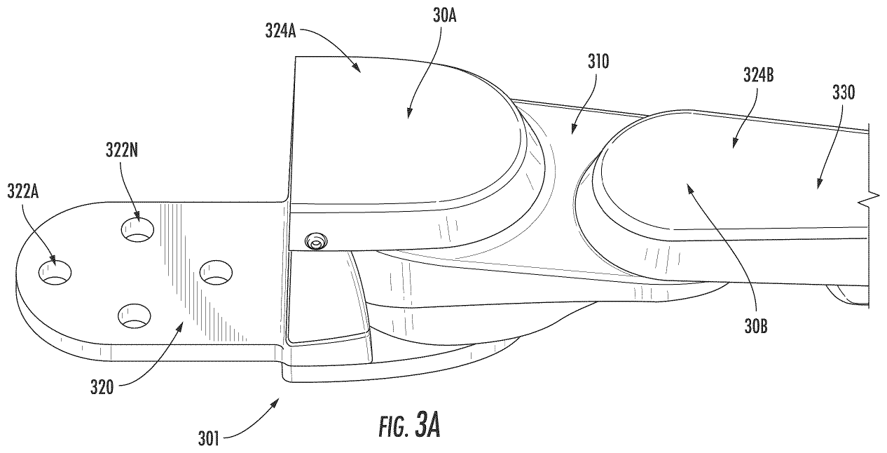

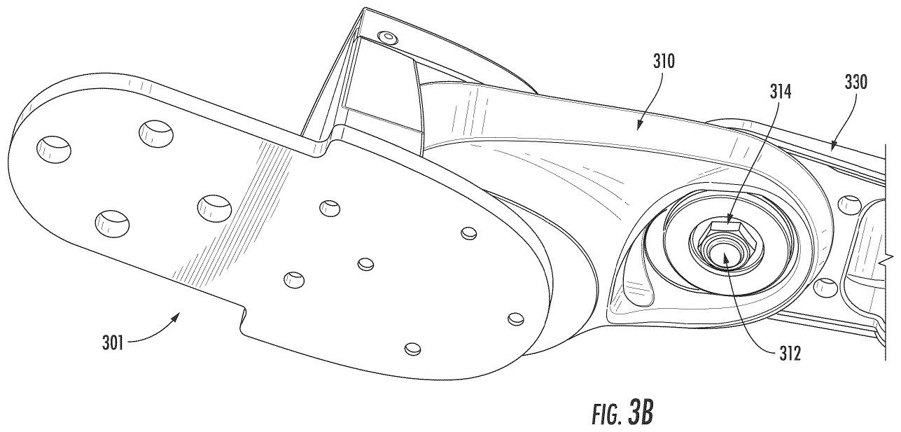

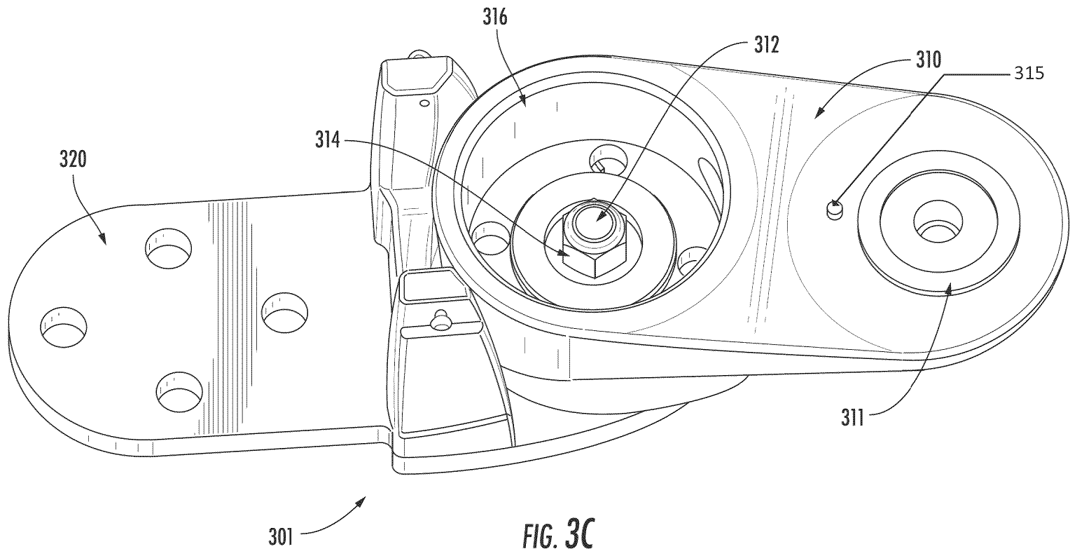

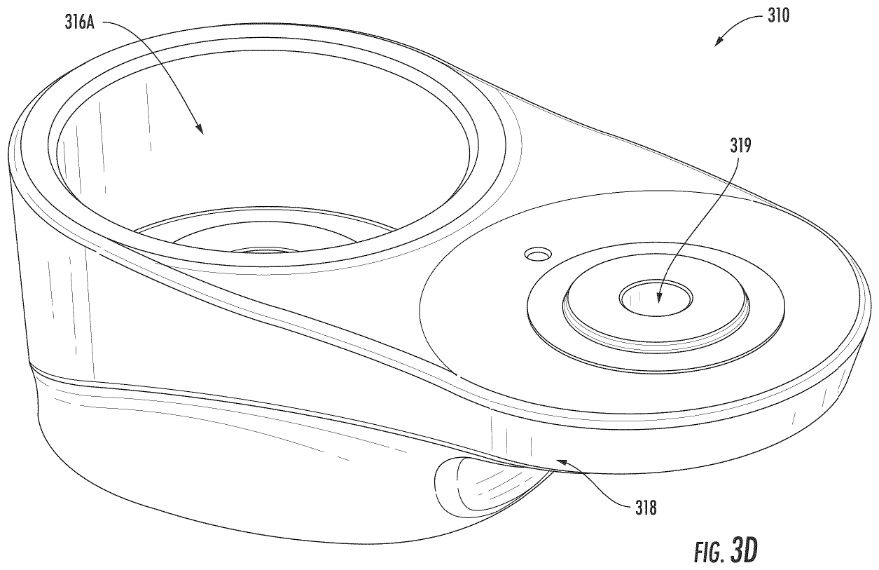

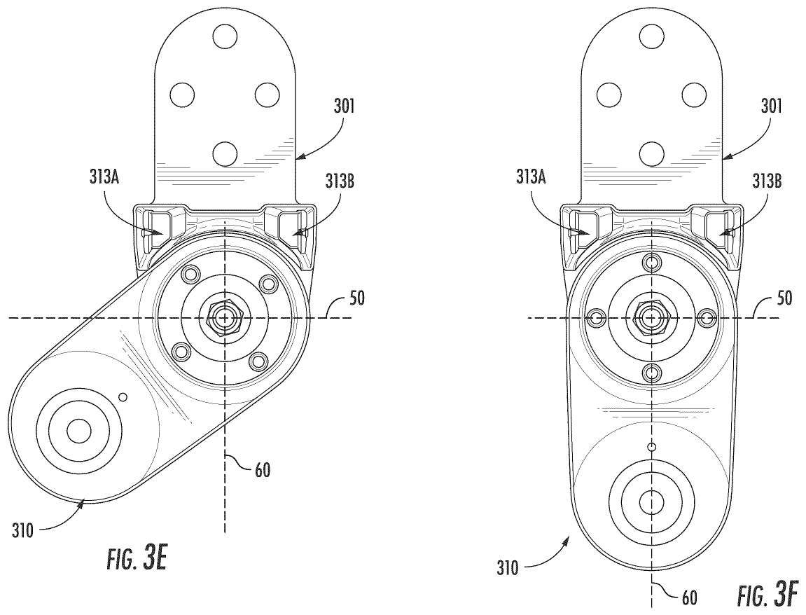

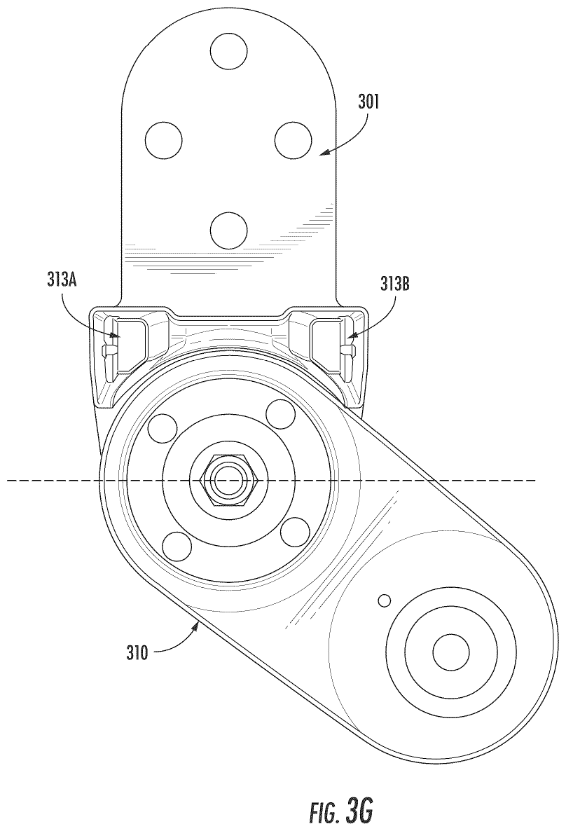

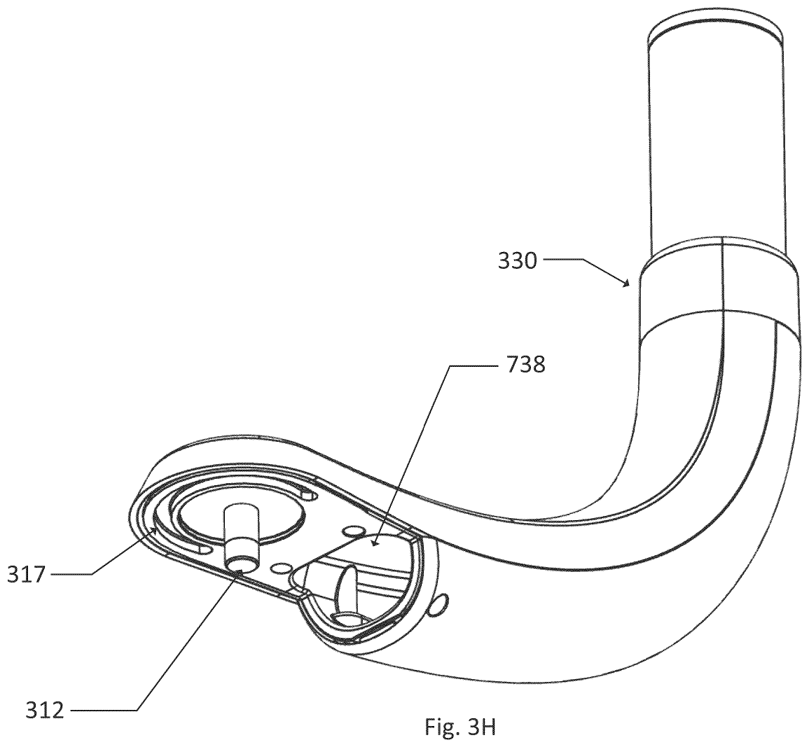

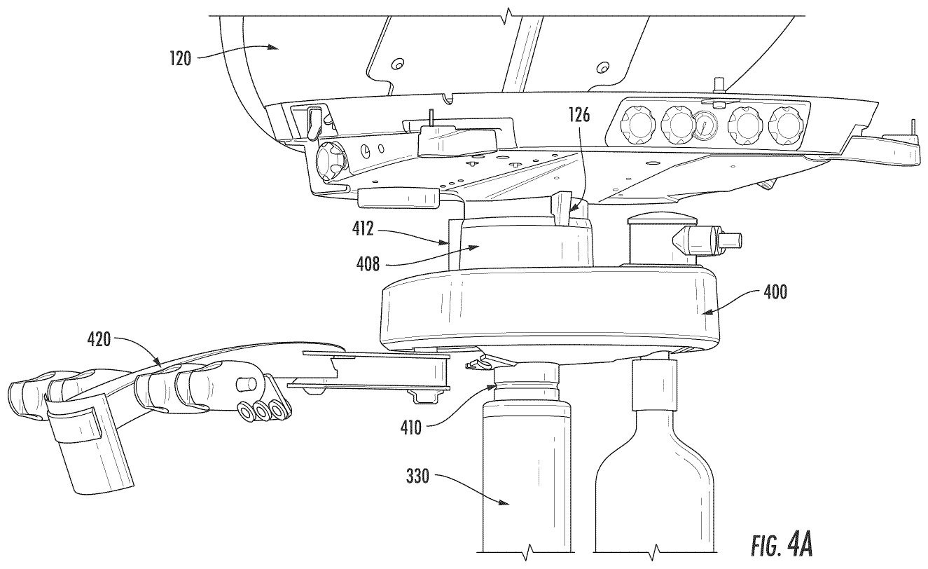

FIGS. 3A-3G depict exemplary perspective views of a stationary mount 301, movement arm 310, and, in some instances, a portion of the connection arm 330 in accordance with various embodiments of the present disclosure. The movement arm 310 defines at least two connection points (e.g., hinges and/or openings configured to receive hinge components). The at least two connection points comprise a first connection point 30A and a second connection point 30B. The first connection point 30A is defined by the connection location between the stationary mount 301 and the movement arm 310 at or proximate a first end of the movement arm 310. The second connection point 30B is defined by the connection location between the movement arm 310 and the connection arm 330 disposed at a second end of the movement arm 310, wherein the second connection point is disposed opposite of the first connection point. In some embodiments, the first connection point 30A and/or the second connection point 30B may be covered by a portion 324A, 324B (collectively “324”) of the respective stationary mount 301 or connection arm 330. The portions 324 may comprise a plastic material and may secure at least partially to the movement arm 310, the stationary mount 301, and/or the connection arm 330 through one or more fasteners. In some embodiments, the portions 324 may snap on/off from connection with the corresponding component. In some embodiments, the portions 324 may form part of the connection (e.g., an upper side of a hinge) between the respective components. In various embodiments, the mounting plate 320 of the stationary mount 301 may comprise one or more fastener openings 322A-322N (collectively “322”) configured to receive one or more fasteners (e.g., threaded fasteners) to secure the mounting plate 320 to the stationary structure (e.g., the ground and/or the storage system).

In various embodiments, the movement arm 310 and/or the stationary mount 301, including but not limited to the mounting plate 320, may comprise at least a portion of a rigid material, for example, steel, steel alloy, aluminum, and/or the like configured to withstand the weight and the movement of the delivery system. The movement arm 310 and/or the connection arm 330 may comprise a portion that is made at least partially of a plastic material (e.g., plastic covering). In various embodiments, at least a portion of the connection arm 330 and/or the movement arm 310 may be hollow, such that cables and/or conduits (e.g., electrical cable, hoses, tubes, etc.) may be inserted from the bottom and run through at least a portion of the movement arm 310 and connection arm 330 to the delivery portion 120 and/or other components connected to the connection plate 400. The hollow portion may allow for electrical components to be connected and electrically engaged via wires run from the storage system to the storage compartment of the delivery portion.

FIG. 3B depicts a bottom perspective view of an example movement arm 310, portion of a connection arm 330, and stationary mount 301 in accordance with various embodiments of the present disclosure. In the depicted embodiment, the movement arm 310 secures to the connection arm 330 at a second connection point via at least one threaded fastener 312 (e.g., a bolt) extending through openings in each of the respective arms and at least one threaded connector 314 (e.g., a nut) engaging an opposite side of the fastener. For example, the threaded fastener 312 may be inserted into an opening defined by the connection arm 330 first then through an opening defined by the movement arm 310, such that the threaded connector 314 secures to the threaded fastener 312 along a lower side of the movement arm 310. In other embodiments, the threaded fastener 312 may be inserted into an opening defined by the movement arm 310 along the lower side first followed by being inserted into an opening defined by the connection arm 330, such that the threaded connector 314 secures the threaded fastener 312 along an upper portion of the connection arm 330. In various embodiments, the second connection point is defined by the hinge created by the threaded fastener 312 and threaded connector 314 connecting the movement arm 310 and the connection arm 330. The connection point may act like a point of rotation, wherein the movement arm 310 and/or the connection arm 330 may move in a plurality of axes relative to the connection point. In some embodiments, the threaded fastener may be threaded into a portion of the respective components rather than engage a threaded connector. In various embodiments, other known hinging connections may be used.

FIG. 3C depicts a top perspective view of a connection between the movement arm 310 and stationary mount 301 in accordance with various embodiments of the present disclosure. In the depicted embodiment, the movement arm 310 secures to the mounting plate 320 via at least one threaded fastener 312 and at least one threaded connector 314. The threaded fastener 312 may be inserted into an opening defined by the lower side of the mounting plate 320 (or otherwise fixed to the mounting plate) first then through an opening defined by the movement arm 310, such that the threaded connector 314 secures to the threaded fastener 312 within a recess 316 formed in the upper side of the movement arm 310. In other embodiments, the threaded fastener 312 may be inserted into an opening defined by the recess 316 of the movement arm 310 first followed by being inserted into an opening defined by the mounting plate 320, such that the threaded connector 314 secures the threaded fastener 312 along a bottom surface of the mounting plate (not depicted). In various embodiments, the connection point between the movement arm 310 and the mounting plate 320 is defined by the location of the hinge formed by the threaded fastener 312, such that the stationary mount defines a pivot portion engaging the movement arm. The connection point may act like a point of movement, wherein the movement arm 310 may move in a plurality of axes relative to the connection point. In some embodiments, the threaded fastener may be threaded into a portion of the respective components rather than engage a threaded connector. In various embodiments, other known hinging connections may be used.

As further depicted in FIG. 3C, in some embodiments, each of the respective hinging connections may include one or more gaskets 311 or other bearing surfaces configured to support the respectively engaged components while allowing rotation therebetween under the compression created by the fasteners and the weight of the delivery system.

The connection between at least the movement arm 310 and the connection arm 330 may be rotationally limited in some embodiments to prevent contact between the connection arm and the mount or other impinging surfaces. With reference to FIG. 3C, a distal end of the movement arm 310 may include a pin 315 that is configured to limit the rotation of the connection arm 330 relative to the movement arm 315. With reference to FIG. 3H, the connection arm 330 may have a corresponding groove 317 defined on an underside of the proximal end thereof. The pin 315 is configured to insert into the depicted groove 317 and ride there along. The groove 317 may extend circumferentially about the threaded fastener 312 or another pivot point between the two arms such that the pin may ride along the groove 317 as the two arms rotate relative to each other. In the depicted embodiment, the groove 317 limits the range of motion of the connection arm 330 relative to the movement arm 310 because the groove only extends partially around the threaded fastener 312 causing the pin 315 to impinge on opposing ends of the groove to define its range of motion. In some embodiments, the pin and slot may be reversed between the arms.

FIG. 3D depicts an isolated perspective view of an example movement arm in accordance with various embodiments of the present disclosure. In the depicted embodiments, the movement arm 310 comprises a recess 316 and/or a curved body portion 318 of the movement arm 310. The recess 316 is disposed on a first send of the movement arm. The recess 316 is configured to define, at least partially, the location of the first connection point. The recess 316 further allows for a user to easily access the threaded fastener and/or threaded connector securing the movement arm 310 with the mounting plate. The curved body portion 318 of the movement arm 310 is disposed at a distal end relative to the recess 316, such that the first connection point may bear upon and be supported by the stationary mount 301 while the second connection point may be spaced sufficiently far from the ground to allow a user's foot to be disposed beneath the connection (e.g., beneath opening 319). For example, the curved body portion 318 may comprise a radius scalloped shape, such that the curved body portion is disposed vertically above the ground that the delivery system is secured to in some embodiments. In the depicted embodiment, the curved body portion 318 may be disposed vertically tall enough from the ground that a user can fit at least one foot underneath the movement arm 310 at the second connection. As described further herein, the curved body portion may also define a cavity for receiving one or more conduits and/or cables therein. In various embodiments, the curved body portion 318 may comprise any radius shape that would prevent at least a portion of the movement arm 310 from contacting the ground. The movement arm 310 may further define at least one opening 319 configured to receive a threaded fastener to secure the movement arm 310 to the connection arm. The opening 319 is configured to define the second connection point of the movement arm, and the second connection point is opposite to the first connection point relative to the length of the movement arm 310.

FIGS. 3E-3G illustrate exemplary top views a movement operation of a movement arm 310 relative to the stationary mount 301 in accordance with various embodiments of the present disclosure. In various embodiments, the movement arm 310 may be positioned in a first position (e.g., depicted in FIG. 3E). The movement arm may move in an arc relative to the connection point (e.g., defined at the intersection of the axes 50, 60), such that the movement arm 310 rotates from the first position to one or more additional positions (e.g., depicted in FIG. 3F). By way of example, the movement arm 310, as depicted in FIG. 3E, may be in a “starting position”. The starting position may be defined by the location, in which the movement arm is prevent from moving further in one direction by one or more barriers 313A, 313B (collectively “313”). The mounting plate 320 may define the one or more barriers 313 that prevent the movement arm from over rotating. In other embodiments, the movement arm 310 may comprise one or more barriers that prevents the movement arm from over rotating (e.g., by contacting the stationary mount or an adjacent structure, such as the storage system). The movement arm 310 may be configured to move from the starting position to at least one additional position (e.g., the position depicted in FIG. 3F), wherein the additional position may be disposed anywhere between the starting position and an ending position (e.g., depicted in FIG. 3G). The movement arm 310 may be configured to rotate 180 degrees. In other embodiments, the movement arm may be configured to rotate a greater amount than 180 degrees. In the depicted embodiment, the movement arm may rotate less than 180 degrees.

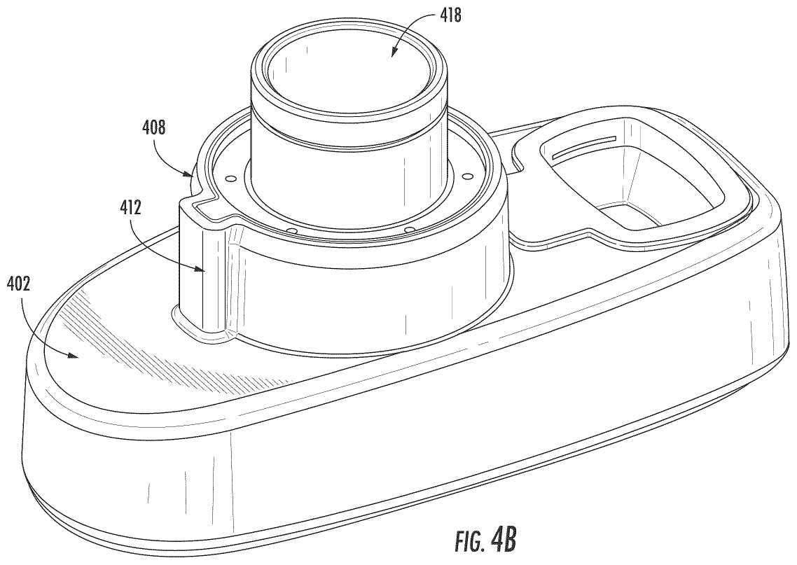

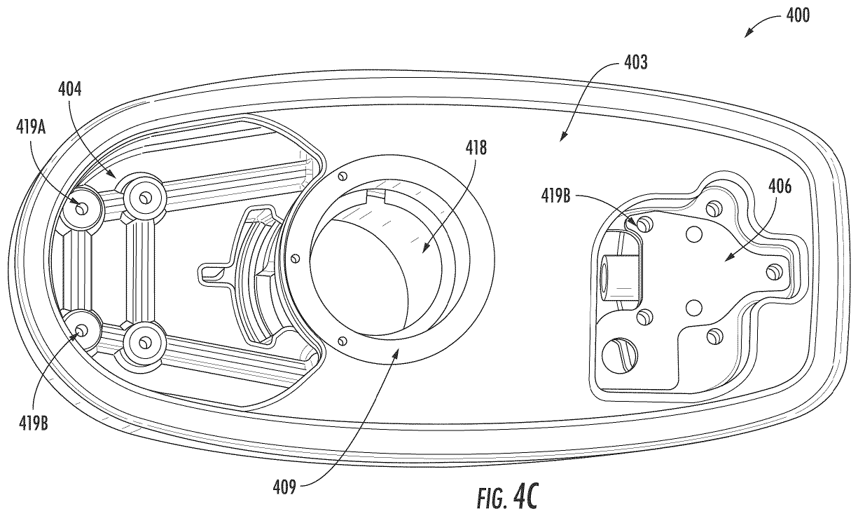

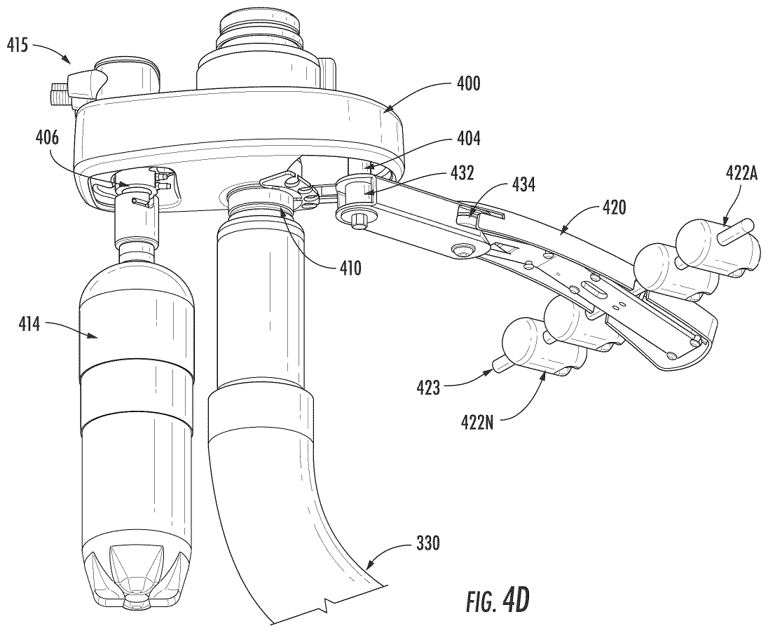

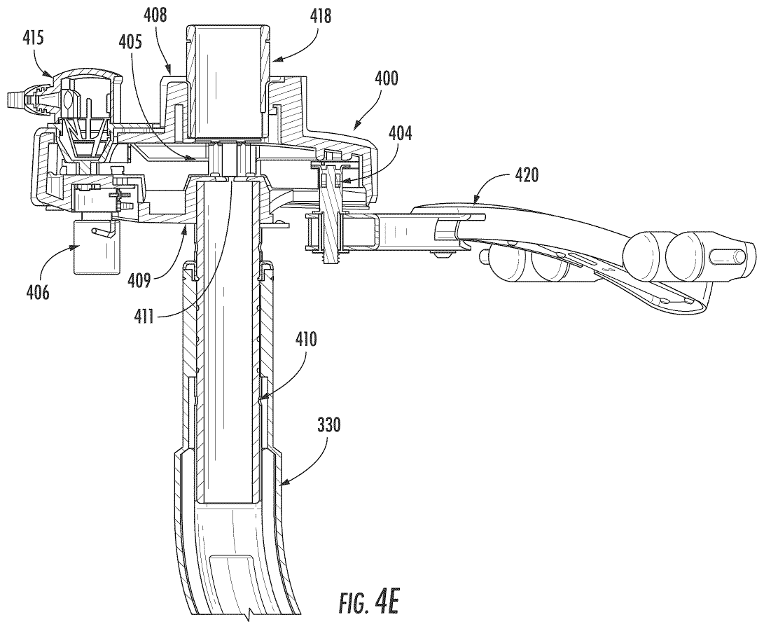

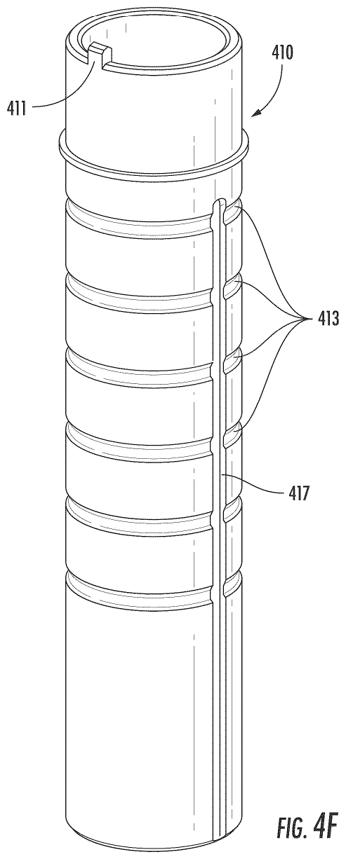

FIG. 4A depicts a perspective view of a connection plate 400 in accordance with various embodiments of the present disclosure. The connection plate 400 may comprise an upper side and a lower side and may define one or more connectors for facilitating communication and support between the various components at the end of the connection arm 330. The connection plate 400 may include, by way of example at least a delivery portion connector 408, a tool arm connector 404, a detachable bottle connector 406, and/or a connection arm connector 409 (shown in FIG. 4B). The delivery portion connector 408 may be disposed on the upper side of the connection plate 400 and configured to engage the delivery portion 120 from beneath. In some embodiments, the delivery portion connector 408 may further comprise a protrusion 412 that extends from the delivery portion connector 408. The connection plate 400 is configured to connect the delivery portion 120 to the connection arm 330. The connection plate 400 engages the delivery portion 120 via the delivery portion connector 408 on the upper side of the connection plate 400. The connection plate 400 further secures the delivery portion 120 to the connection arm 330 via the connection arm connector 409 (shown in FIG. 4C) which may engage the connection arm 330 (e.g., via an extendable portion 410 of the connection arm). The connection arm connector 409 may be disposed on an opposite side of the connection plate 400 relative to the delivery portion connector 408. In some embodiments, the connection arm connector 409 facilitates a connection between the connection plate 400 and the connection arm 330 in a manner, such that the connection arm connector 409 may prevent the connection plate 400 from rotating relative to the connection arm 330.

In various embodiments, the delivery portion 120 may connect with the delivery portion connector 408 of the connection plate 400 in a manner, such that the delivery portion 120 may rotate relative to the connection arm 330 (e.g., a rotatable connection). The protrusion 412 extending from the delivery portion connector 408 may engage with a corresponding protrusion 126 on the delivery portion 120 to limit the maximum rotation of the delivery portion to less than 360 degrees. For example, the two protrusions 126, 412 prevent the delivery portion 120 from completing a fully rotation relative to the connection arm 330.

FIGS. 4B-4C illustrate isolated perspective views of the connection plate 400 in accordance with various embodiments of the present disclosure. In various embodiments, the connection plate 400 may comprise a rigid material, for example, steel, steel alloy, aluminum, and/or the like configured to withstand the weight and the movement of the delivery portion. In some example embodiments, the connection plate 400 may comprise a plastic material, and in some instances, the plastic material is strong enough to withstand the weight of the delivery portion. FIG. 4B depicts an exemplary upper side 402 of the connection plate 400. The upper side 402 defines a delivery portion connector 408 and/or a protrusion 412 of the delivery portion connector 408. The delivery portion connector 408 may further define a channel 418, wherein the channel 418 extends through the connection plate 400 connecting the connection arm to the storage compartment of the delivery portion. The channel 418 may extend into the lowermost portion of the delivery portion 120 to allow the delivery portion to rotate while the delivery portion is supported by the connection plate (e.g., by the channel, by any other portion of the delivery portion connector 408, or the like). The channel 418 allows for one or more electrical cables (e.g., electrical wires, etc.), one or more conduits, and/or other components to run from the stationary mount 301, through the connection arm 330 and/or movement arm 310 to the delivery portion 120 of the delivery system. The delivery portion connector 408 is further configured to allow for the delivery portion to rotate about the delivery portion connector 408 relative to the connection arm 330 and the connection plate 400. In some embodiments, at least a portion of the upper side 402 may comprise rounded edged, chamfered edge, or the like. In some embodiments, the delivery portion 120 may engage the channel 418 at a location other than the horizontal geometric center of the delivery portion such that the delivery portion rotates asymmetrically. In some embodiments, the delivery portion 120 may engage the channel 418 at a location of the horizontal geometric center of the delivery portion such that the delivery portion rotates symmetrically.

With reference to FIG. 4C, in various embodiments, the lower side 403 of the connection plate 400 defines a tool arm connector 404 and/or a detachable bottle connector 406. The tool arm connector can receive a first arm (e.g., arm 420 shown in FIG. 4D) and/or one or more additional arms, wherein the arms can hold one or more tools or any other components used by the practitioner and/or patient. The detachable bottle connector 406 can receive a detachable bottle. The detachable bottle (e.g., bottle 414 shown in FIG. 4D) may be removed/attached to the connection plate 400 by the user using a twist lock, thread, or other known connector. The detachable bottle may be selectively attached by the user, such as when a bottle is full/empty. In various example embodiments, the detachable bottle connector 406 is positioned on an opposite horizontal side relative to the tool arm connector 404 on the lower side 403. In other embodiments, one or both of the tool arm connector 404 and the detachable bottle connector 406 may be on a top side of the connection plate 400, on a lateral edge of the connection plate, and/or attached to other structures in the delivery system 100. In some embodiments, the detachable bottle connector 406 and the tool connector 404 may be on the same horizontal side of the connection plate 400. The detachable bottle 403 may define one or more fastener opening 419A, 419B-419N (collectively “419”). The fastener openings 419 receive one or more fasteners to secure a variety of components to the connection plate 400 including but not limited to the tool arm connector 404 and/or to the detachable bottle connector 406. In some embodiments, the fasteners may secure the first arm 420 and/or one or more additional arms to the tool arm connector 404, may secure a detachable bottle 414 to the detachable bottle connector 406, and/or the like. In various embodiments, the tool arm connector 404 may be disposed linearly opposite of the detachable bottle connector 406, wherein the tool arm connector 404 is on a first lateral end of the connection plate and the detachable bottle connector 406 on a second lateral end of the connection plate. The first arm 420 and the detachable bottle 414 may thereby be stationary relative to the connection plate 400 during use.

With reference to FIG. 4D, in various embodiments, the first arm 420 and/or at least one detachable bottle 414 secures to the lower side of the connection plate 400 via the tool arm connector 404 and the detachable bottle connector 406 respectively. The arm 420 may be constructed in a manner, in which, the arm 420 may rotate about a first connection point 432 and/or a second connection point 434. The first connection point may be defined partially by the connection of the arm 420 to the tool arm connector 404, which may extend downward from an interior cavity of the connection plate 400 that is open to the lower side. The second connection point 434 may be defined by the connection point of a first arm segment securing to a second arm segment to allow the arm 420 to articulate. The first arm segment and/or the second arm segment may rotate/move relative to each other. A user may configure the arm 420 in a variety of positions by selectively moving and/or rotating the arm 420 about the first connection point 432 and/or the second connection point 434. In some embodiments, the at least one arm 420 may comprise one or more holders 422A-422N (collectively “422”) configured to hold one or more items selected by the user. The holders 422 may hold tools and other components (e.g., tubes, hoses, dental equipment, surgical equipment, and/or the like, which may include drills, polishers, mirrors, retractors, probes, lasers, wrenches, burs, and any other tool or other equipment). In some embodiments, the holders 422 may be affixed to the arm via a connection rod 423. The holders 422 may be secured to the connection rod 423, such that the holders may or may not be adjusted. In various embodiments, the detachable bottle 414 is selectively detachable to the detachable bottle connector 406, such that the user may secure and/or disconnect the detachable bottle 414. The depicted embodiment further includes a utility supply inlet 415 for delivering one or more utilities to the delivery portion, including one or more air, water, and/or vacuum supplies. In some embodiments, one or more of the various utilities delivered via the utility supply inlet 415 may interact with fluid in the detachable bottle to drive the fluid from the bottle and into the tools held by the arm 420.

With reference to FIG. 4E, a cross-section of the assembly of FIG. 4D is shown. In the depicted cross-sectional view, the connection plate 400 is shown having the channel 418 inserted into the remaining delivery portion connector 408. The connection plate 400 is further engaged with the extendable portion 410 of the connection arm 330 via a connection portion connector 409. The extendable portion 410 may be raised and lowered manually (e.g., by a user moving the connection plate 400 and/or extendable portion 410 upwards and downwards and securing, whether passively or actively, the extendable portion at a desired length) or automatically (e.g., via a pneumatic or hydraulic piston). Moreover, in the depicted embodiment, the extendable portion 410 is rotationally locked with the connection plate 400 via a protrusion 411 engaging a corresponding slot in the connection arm connector 409, which slot is also depicted in FIG. 4C. FIG. 4F depicts an isolated view of the extendable portion 410 of the connection arm 330 showing the protrusion 411 and a vertical groove 417 configured to rotationally lock the extendable portion 410 with the vertical, integral section of the connection arm 330. The depicted extendable portion 410 also includes a plurality of horizontal, circumferential grooves 413 configured to define the various height positions at which the extendable portion 410 can be set. In some embodiments, the extendable portion 410 may facilitate the height adjustment of the delivery portion by 3 or more inches. In some embodiments the extendable portion 410 may facilitate the height adjustment of the delivery portion by 6 or more inches. In the depicted embodiment, the height adjustment is facilitated via engagement of the depicted plastic collar with one of the plurality of grooves which collar then cooperates with the grooves and the inner diameter of the body of the connection arm 330 to retain the extendable portion 410 at a predetermined height.

With continued reference to FIG. 4E, the connection plate 400 may define a gap 405 between, on the one hand, the connection portion connector 409 and the extendable portion 410 and, on the other hand, the delivery portion connector 408 and the channel 418. The gap 405 may be configured to facilitate communication, via the interior of the connection plate, of the various components attached to or through the delivery portion, including providing space for the various cables and/or conduits to pass through the connection plate to and/or from one or more of the delivery portion, the connection arm 330, the detachable bottle connector 406, and/or the one or more arms 420. As further depicted in FIG. 4E, in some embodiments, the channel 418 configured to engage the delivery portion 120, a vertical portion of the connection arm 330, and the extendable portion of the connector arm 410 may be aligned on a vertical axis.

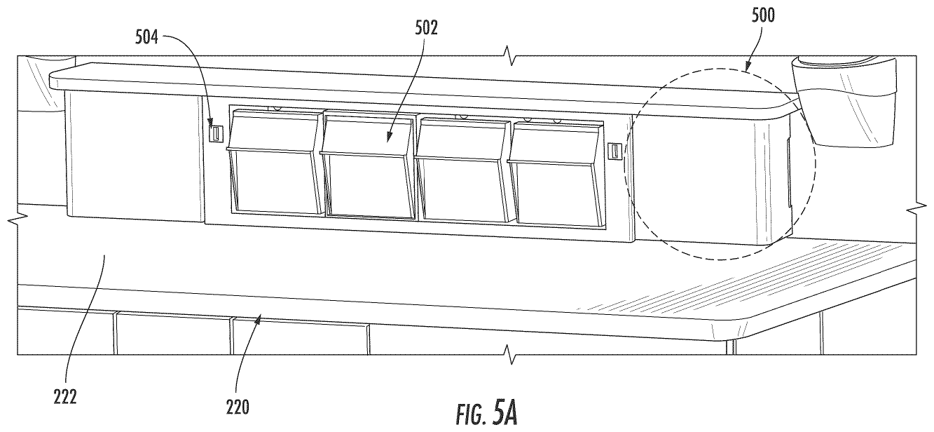

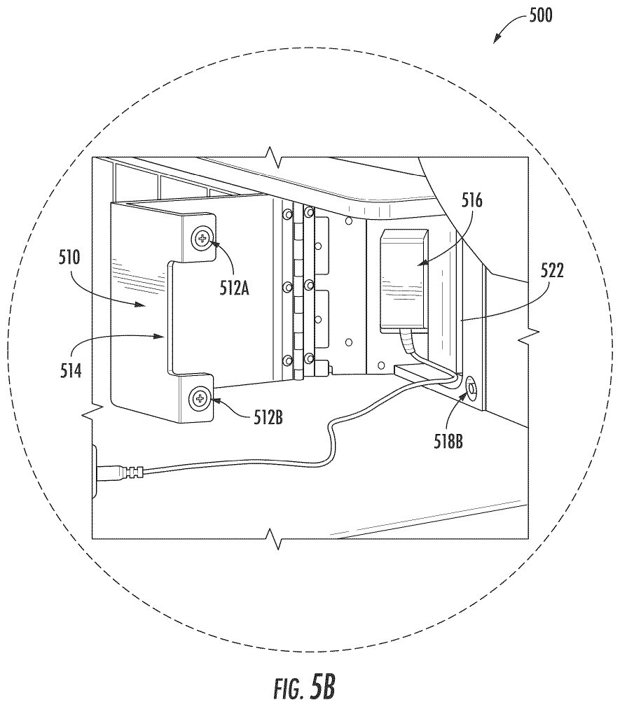

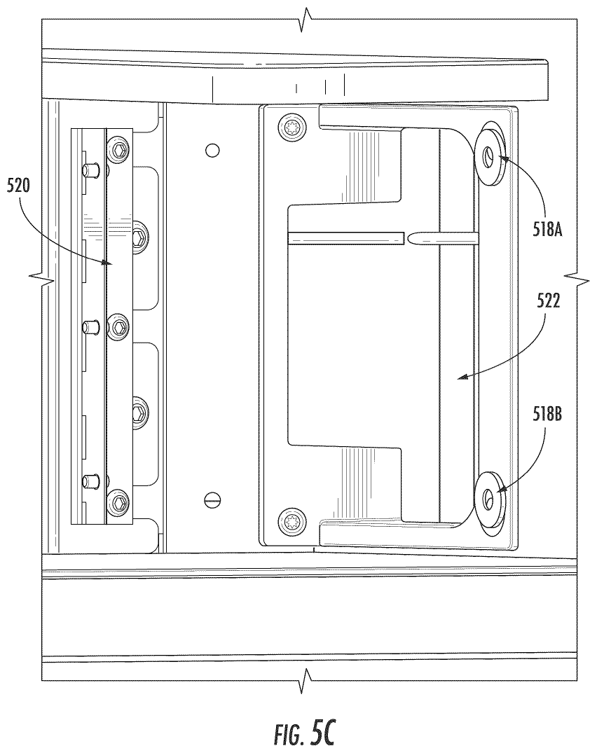

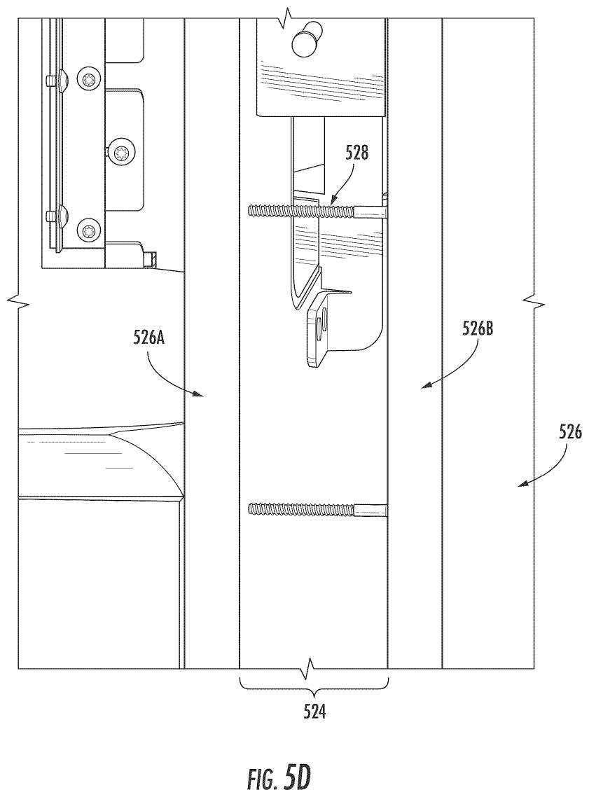

FIGS. 5A-5D depicted perspective view of an example electrical connection system 500 of the storage system in accordance with various embodiments of the present disclosure. At least a portion of the electrical connection system may be angled and configured to secure to the counter portion 220 of the dental system. The angled portion of the electrical connection system allows for a user position in front of the counter to access a door of the system. In some embodiments, the electrical connection system 500 may extend along at least a portion of the flat surface 222 of the counter portion 220. In some embodiments, the electrical connection system 500 may extend the entire length of the flat surface 222 of the counter portion 220. In various embodiments, the electrical connection system 500 may be attached at least partially to the flat surface via one or more fasteners. In other embodiments, the electrical connection system 500 may be integrated at least partially into the flat surface. In some embodiments, the electrical connection system 500 may comprise one or more external electrical connections 504 (e.g., USB ports) to provide power and/or data access to one or more external computing or other electronic devices.

In various embodiments, the electrical connection system 500 may comprise one or more bin(s) 502. In the depicted embodiment, the bins are shown disposed in the middle of electrical connection system 500. The bins 502 may be a clear plastic material, such that the user is able to see the contents of the bins. In various embodiments, the bins 502 may be configured to slide and/or tilt relative to the electrical connection system 500. For example, the bins 502 may be configured to tilt from a close configuration (e.g., depicted in FIG. 5A) to an open configuration, wherein the user may be able to access the contents of the bin in the open configuration. The bins 502 may be configured to tilt about a pivot point at or proximate a bottom of the bins, such that the bottom portion of the bin may act like a point of rotation.

With reference to FIG. 5B, the electrical connection system 500 may include at least one door 510 at least partly covering an internal area of the electrical connection system. The electrical connection system 500 may further include an electrical connection point (e.g., electrical socket) 516 and/or a channel 522 within the internal area. In some embodiments, the door 510 comprises one or more connection elements (e.g., magnets, clamps, latches, etc.) 512A, 512B (collectively “512”) configured to assist with securing the door 510 in a closed configuration with one or more corresponding receiving elements 518A, 518B (e.g., depicted in FIG. 5C, collectively “518”). In various embodiment, the respective connection and receiving elements may be disposed opposite one another respectively either on the door or a stationary component (e.g., the surrounding shell or wall). In the depicted embodiment, first connection element 512A is disposed vertically above a second connection element 512B along an inner surface of the door. The depicted first connection element 512A secures to the first receiving element and the second connection element 512B secures to the second receiving element 518B.

With continued reference to FIG. 5B, the depicted door 510 further comprises a slot 514. The slot 514 may be used as a grasping point for the user to open the door 510 from the closed configuration. The slot 514 allows for the user to easily move the door 510 from a closed configuration to an open configuration while the user is standing in the middle of the electrical connection system 500. The slot 514 may additionally or alternatively be used to permit one or more electrical wires from the electrical connection point 516 to pass through the slot 514 in the door 510 to reach the flat surface 222 while the door 510 is in the closed configuration. In various embodiments, the door 510 may comprise at least partially an angled outer surface allowing users standing in front of the counter portion to easily interact with the door 510. In some embodiments, the electrical connection system 500 may further comprise a channel 522, where the channel 522 allows the user access to a gap in between the wall (e.g., between two spaced panels of the storage system, between a rear of the storage system and an exterior wall of the surrounding room and/or within a wall of the surrounding room) to run extra electrical cables through. In the depicted embodiment, the electrical connection system 500 defines an opening to the channel, which channel is formed at least partially in a rear backsplash wall portion of the storage system.

In some embodiments, the electrical connection system 500 may comprise two angled portions, wherein a first angle is on a first side and a second angled portion is on a second side. The two angled portions may be disposed linearly opposite of each other. In various embodiments, the two angle portions may each comprise a door, wherein each door is configured to house an electrical connection. The electrical connections may be disposed behind each individual door while in the closed configurations. In various embodiments, the first angled portion and the second angled portion may be furthered configured to define a first channel and a second channel. The first channel and second channel both may be defined by the same wall segments, wherein the distance between a first wall segment and a second wall segment define the width of the channel.

With further reference to FIG. 5B, in various embodiments, one or more electrical connection points 516 may be disposed behind a door 510 while the door is in the closed configuration. The electrical connection points 516 may be configured to be at an angled, wherein the electrical connections and the door are set to a similar angle. In other embodiments, the electrical connections may be aligned with the hinge of the respective door. The electrical connection points (e.g., electrical socket) 516 may be accessed once the door 510 is translated into the open configuration. The electrical connection points 516 may receive the prong end of an electrical component (e.g., to provide the electrical component with electricity). The electrical connection points 516 may be positioned along the angled portion of the electrical connection system 500, such that the electrical connection points 516 may be easily accessed while a user is positioned in front of the electrical connection system 500. In various embodiments, the electrical connection points 516 may be further disposed orthogonal to the channel 522, such that the extra electrical cables may be easily placed within the channel 522.

FIG. 5C depicts a perspective view of an example components of the electrical connection system 500 in accordance with various embodiments of the present disclosure. The door 510 may be configured to rotate from a closed configuration to an open configuration via at least one hinge 520. In various embodiments, the hinge may be a ball-bearing hinge, a barrel door hinge, a concealed hinge, an overlay hinge, a butt hinge, an offset hinge, a spring hinge, and/or the like. The hinge may be configured to keep the door in the open configuration without the assistance of the user. The at least one hinge 520 may secure to a portion of the upper storage portion of the dental system via one or more fasteners. In various embodiments, the first receiving element 518A may be secured at least partially to the wall and may be disposed vertically above the second receiving element 518B secured on the same wall portion. The first receiving element 518A and/or the second receiving element 518B assist with keeping the door in the closed configuration. While the door is in the open configuration, as depicted, the user can access the channel 522 to feed extra electrical cables into a gap between two wall portions.

FIG. 5D depicts an exemplary cross-sectional view of a wall 526 in accordance with various embodiments of the present disclosure. In the depicted embodiment, a gap 524 may be defined by a first wall surface 526A and a second wall surface 526B (e.g., the wall 526 may be at least partially hollow). In the depicted embodiment, the wall 526 is part of the storage system. The width of the gap 524 may be further defined by the length of one or more fasteners 528 used to secure the second wall surface 526B to the first wall surface 526A. The gap 524 may receive additional portions of electrical cables from one or more electrical devices connected to the electrical connection point. The electrical cables may be fed into the gap 524 from the channel 522 located on the first wall surface 526A.

FIG. 6 illustrates an example embodiment of portions of a delivery system that may be individually, collectively, or in any various combination or subcombination be substituted into or used with the other embodiments of the delivery system discussed herein. In the embodiment of FIG. 6, the connection arm 330 may be identical or substantially identical to the connection arm described herein with respect to FIG. 4A. The connection arm 330 may be connected to a second embodiment of a movement arm 610 and, via the movement arm 610, a second embodiment of a stationary mount 601. The depicted movement arm 610 may engage the connection arm 330 at a connection point using similar hinging attachment means to those described herein.

The movement arm 610 may extend horizontally from the stationary mount 601 and may hinge relative to the stationary mount 601 at a first connection point. The movement arm 610 may include a collar section 612 configured to insert into a pivot portion of the stationary mount defined by an upper hinge portion a and a lower hinge portion 616 of the stationary mount 601, with a hinge pin 620 extending vertically therethrough, via axially-aligned openings in each of the upper hinge portion, the lower hinge portion, and the collar section. The upper hinge portion 614 and the lower hinge portion 616 may extend from a vertical plate 618 of the stationary mount. In the depicted embodiment, the vertical plate 618 further includes an opening 622 through which cables, conduits, and/or the like may extend (e.g., cables and/or conduits passing into/out of the connection arm 330).

With continued reference to FIG. 6, the stationary mount 601 may be mounted to a stationary structure (e.g., the ground and/or an adjacent cabinet 660). In the depicted embodiment, the bottom cabinet 660 includes a lower kickplate 662. The stationary mount 601 is mounted to the ground and may optionally be mounted at least partially to the kickplate 662. The stationary mount 601 and movement arm 610 in the depicted embodiment are partially disposed vertically above a lowermost edge of the left and right-side doors 664 of the bottom cabinet 660. In some embodiments, the stationary mount 601 and/or the movement arm 610 may be at least partially disposed above a lowermost edge of the lowermost door of the bottom cabinet 660. The bottom cabinet further comprises a truncated door 666 above the stationary mount 601. In the depicted embodiment, a trim panel 668 is disposed in the gap formed by the doors 664, 666 above the kickplate 662 and around the vertical plate 618 of the stationary mount 601. The trim panel 668 may be rigidly fixed to the cabinet structure. The embodiment of FIG. 6 may include some or all of the same functions and benefits as the preceding or foregoing embodiments, including but not limited to, efficient movement and use of the delivery portion, improved access to the various tools and other components of the delivery system, improved user clearance for the user's knees and/or feet in maneuvering the delivery portion, and the like.

FIGS. 7A-7E depict an example embodiment of portions of a delivery system that may be individually, collectively, or in any various combination or subcombination be substituted into or used with the other embodiments of the delivery system discussed herein. The depicted embodiment includes a bottom cabinet 660 having a truncated door 666, trim plate 768, left and right-side doors 664, kickplate 662, and the like as described with respect to the embodiment of FIG. 6. In the embodiment of FIGS. 7A-7E, the stationary mount 701 and movement arm 710 are modified versions of the corresponding stationary mount 601 and movement arm 610 of FIG. 6 and either or both may be substituted with the other various embodiments discussed herein.

With reference to FIG. 7A, the depicted stationary mount 701 includes a vertical plate 718 comprising an upper hinge portion 714 and a lower hinge portion 716 configured to pivotally support a collar section 712 of the movement arm 710 via a pin (e.g., pin 720 shown in FIG. 7C) extending therebetween. The depicted embodiment further includes a cover 724 covering the top of the hinge pin 720. The movement arm 710 may connect to and extend between the stationary mount 701 and the movement arm 330. In some embodiments, the lateral sides of the vertical plate 718 adjacent to and intersecting a common horizontal plane (e.g., a plane of rotation of the movement arm) with the collar section 712 of the movement arm 710 may extend outward from the vertical plate surface at least partially to serve the same rotation-limiting function as the barriers 313A, 313B shown in FIGS. 3A-3C, 3E-3G. The delivery system in the depicted embodiment may facilitate positioning and movement of the delivery portion in substantially the same manner as the other embodiments described herein.

With reference to FIG. 7B, a rear, bottom perspective view of the stationary mount 701 and a basement area of the bottom cabinet are shown in accordance with various embodiments of the present disclosure. In the depicted embodiment, the stationary mount 701 includes the vertical plate 718 including the hinge portions described above. The stationary mount 701 may further include a mounting plate 726 and a vertical mounting plate 728 connected perpendicular to each other, with the mounting plate 726 configured to attach to the ground and/or another stationary structure (e.g., via one or more fasteners as described herein with respect to one or more other mounting plate embodiments) and the vertical mounting plate 728 configured to engage the vertical plate 718 to rigidly connect the mounting plate and the vertical plate (e.g., via one or more fasteners 732 between the vertical plate and the vertical mounting plate). One or more angle braces 730 may be used to further strengthen the connection between the mounting plate 726 and the vertical mounting plate 728. As further depicted in FIG. 7B, the kickplate 662 includes an opening 734 into which the stationary mount 701 extends to permit a flush, recessed, or type of positional relationship between the cabinet and the stationary mount.

FIG. 7C shows a lower perspective view of the example stationary mount 701, movement arm 710, and portion of the connection arm 330. The connection arm 330 may engage the movement arm 710 in substantially the same manner as described for the embodiment shown in FIGS. 3A-3C. In the depicted embodiment, the movement arm 710 includes a slightly downward contour of its upper surface between the stationary mount 701 and the connection point of the connection arm 330. The hinge pin 720 is shown in FIG. 7C rotatably securing the movement arm 710 to the stationary mount 701. The hinge pin 720 may engage the respective component in any of a number of manners, including one or more pins, set screws, threading on one or more of the components (e.g., threading on the lower hinge portion 716), or the like so long as the hinge pin still allows the movement arm 710 to move relative to the stationary mount 701. In the various embodiments disclosed herein, each of the movement arm, the delivery portion, and the connection arm may rotate about respective parallel vertical axes.

In the depicted embodiment, each of the stationary mount 701, the movement arm 710, and the connection arm 330 includes cable and/or conduit routing portion configured to facilitate the delivery of various utilities (e.g., electricity, vacuum, air, water, etc.) to and/or from the delivery portion 120. With continued reference to FIG. 7C, the stationary mount 701 includes an opening 722 formed in the vertical plate 718 and the vertical mounting plate 728 configured to receive components (e.g., cables and/or conduits) therethrough. The movement arm 710 includes a cavity 736 also configured to receive at least a portion of one or more components (e.g., cables and/or conduits), including those components that may extend between the connection arm 330 and the stationary mount 701. In some embodiments, the cavity 736 of the movement arm is open along a lower side of the cavity such that the portion of the cable and/or conduit may be inserted and/or removed from the cavity without disconnecting or disassembling the movement arm. Moreover, the depicted connection arm 330 includes a channel 738 configured to receive one or more components (e.g., cables and/or conduits) therethrough. In the depicted embodiment, the connection arm 330 includes a lower shroud 740 configured to be removed to allow access to the cables and/or conduits therein and positioning of the cables and/or conduits within the channel 738 without disconnecting or disassembling the connection arm 330.

FIGS. 7D-7E show isolated upper perspective and lower perspective views of the movement arm 710 according to example embodiments of the disclosure. In the depicted embodiments, the various portions of the movement arm, including the cavity 736, are visible, and the depicted example of the movement arm 710 includes a downward contour of the upper surface in a direction from the first connection point 742 (e.g., the location to which the stationary mount connects) to the second connection point 744 (e.g., the location to which the connection arm connects). In the depicted embodiment, each connection point 742, 744 includes a flat bearing surface 746 against which the respective stationary mount 701 or connection arm 330 moves during rotation of the arms. Moreover, in the depicted embodiment, the movement arm 710 includes an opening 748 through the arm configured to receive the hinge pin (e.g., hinge pin 720 shown in FIG. 7C) and a connection arm receiving opening 750 configured to receive a corresponding fastener for engaging the connection arm and the movement arm. The movement arm 710 may likewise include an opening for receiving a threaded fastener therethrough (e.g., as shown in FIGS. 3A-3G and 7F. As with the various other components and embodiments, the movement arm 710 or portions thereof may be used interchangeably with the other embodiments disclosed herein. The embodiment of FIGS. 7A-7E may include some or all of the same functions and benefits as the preceding embodiments, including but not limited to, efficient movement and use of the delivery portion, improved access to the various tools and other components of the delivery system, improved user clearance for the user's knees and/or feet in maneuvering the delivery portion, and the like.

With reference to FIG. 7F, an additional variant of the movement arm 910 is depicted. The movement arm 910 may be used with any of the embodiments disclosed herein. In the depicted embodiment, the movement arm 910 includes two connection points 942, 944 respectively configured to engage a stationary mount and connection arm. The movement arm 910 further includes a receiving opening 950 for receiving a threaded fastener of the connection arm, a flat bearing portion 946, and a pin 915 for limiting the range of motion of the connection arm in substantially the same manner as discussed with respect to the embodiment of FIG. 3H. The depicted embodiment of FIG. 7F further includes a recessed flat bearing portion 947 in the collar portion 912 to allow rotation of the movement arm relative to the stationary mount while providing a deeper collar to support and stabilize the rotation.

FIG. 8 is a schematic representation of example components in an example controller engaging the various controllable components of the delivery system 802 in accordance with various aspects of the present disclosure. FIG. 8 shows a schematic block diagram of an example circuitry of the delivery system, some or all of which may be included in controller 800. In accordance with some example embodiments, circuitry may include various means, such as processing circuitry 810, communication element 820, input/output element 830, and/or memory 840. In some embodiments, such as when circuitry is included in controller 800. Although these components (e.g., processing circuitry 810, memory 840, etc.) are described with respect to functional limitations, it should be understood that the particular implementations necessarily include the use of particular hardware, software, and/or firmware. It should also be understood that certain of these components (e.g., processing circuitry 810, memory 840, etc.) may include similar or common hardware. For example, multiple sets of circuitries may both leverage use of the same processor, network interface, storage medium, or the like to perform their associated functions, such that duplicate hardware is not required for each set of circuitry.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with controller 800 may provide or supplement the functionality of particular circuitry. For example, the processing circuitry 810 may provide processing functionality, the memory 840 may provide storage functionality, the communication element 820 may provide network interface functionality, and the like.

In some embodiments, the controller 800 can be or comprise a printed circuited board (PCB). In some examples, the controller 800 (e.g., PCB) can further comprise one or more of a full bridge motor driver, a sensor, one or more thermal sensors, one or more user interfaces, one or more protection circuits, configuration management circuitry, a wireless interface, sensing element circuitry (e.g., image sensor circuitry), an interface connector, power control circuitry, gate driver circuitry and/or the like.

The processing circuitry 810 can be embodied as means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, but not limited to, an application specific integrated circuit (ASIC) or field programmable gate array (FPGA), or some combination thereof. Accordingly, although illustrated in FIG. 8 as a single processor, in an embodiment, the processing circuitry 810 can include a plurality of processors and signal processing modules. The plurality of processors can be embodied on a single electronic device or can be distributed across a plurality of electronic devices collectively configured to function as the circuitry controlling the controllable components of the delivery system 802. The plurality of processors can be in operative communication with each other and can be collectively configured to perform one or more functionalities of the circuitry of the robotic system as described herein. In an example embodiment, the processing circuitry 810 can be configured to execute instructions stored in the memory 840 or otherwise accessible to the processing circuitry 810. These instructions, when executed by the processing circuitry 810, can cause the circuitry associated with the controllable components of the delivery system 802 to perform one or more of the functionalities, as described herein.

In various embodiments, the controller 800 may be configured to communicate with one or more controllable components of the delivery system 802 via wireless external communication networks using any of a variety of protocols, such as IEEE 802.11 (Wi-Fi), NFC protocols, RFID protocols, Bluetooth protocols, and/or any other wireless protocol.

Whether configured by hardware, firmware/software methods, or by a combination thereof, the processing circuitry 810 can include an entity capable of performing operations according to embodiments of the present disclosure while configured accordingly. Thus, for example, when the processing circuitry 810 is embodied as an ASIC, FPGA or the like, the processing circuitry 810 can include specifically configured hardware for conducting one or more operations described herein. Additionally, or alternatively, when the processing circuitry 810 is embodied as an executor of instructions, such as can be stored in the memory 840, the instructions can specifically configure the processing circuitry 810 to perform one or more algorithms and operations described herein.

Thus, the processing circuitry 810 used herein can refer to a programmable microprocessor, microcomputer or multiple processor chip or chips that can be configured by software instructions (applications) to perform a variety of functions, including the functions of the various embodiments described above. In some devices, multiple processors can be provided dedicated to wireless communication functions and one processor dedicated to running other applications. Software applications can be stored in the internal memory before they are accessed and loaded into the processors. The processors can include internal memory sufficient to store the application software instructions. In many devices, the internal memory can be a volatile or nonvolatile memory, such as flash memory, or a combination thereof. The memory can also be located internal to another computing resource (e.g., enabling computer readable instructions to be downloaded over the Internet or another wired or wireless connection.

The memory 840 can include suitable logic, circuitry, and/or interfaces that are adapted to store a set of instructions that is executable by the processing circuitry 810 to perform predetermined operations. Additionally, or alternately, the memory 840 can be configured to store data/information, application programs, instructions, etc., so that the controller 800 can execute various functions according to the embodiments of the present disclosure. For example, in at least some embodiments, the memory 840 is configured to cache input data for processing by the processing circuitry 810. Thus, in at least some embodiments, the memory 840 is configured to store program instructions for execution by the processing circuitry 810. The memory 840 can store information in the form of static and/or dynamic information. When the functions are executed, the stored information can be stored and/or used by the controller 800. Example memory embodiments can include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an example embodiment, the memory 840 can be integrated with the processing circuitry 810 on a single chip, without departing from the scope of the disclosure.

The communication element 820 can be implemented as any apparatus included in a circuit, hardware, a computer program product, or a combination thereof, which is configured to receive and/or transmit data from/to another component or apparatus. The computer program product comprises computer-readable program instructions stored on a computer-readable medium (for example, the memory 840) and executed by a controller 800 (for example, the processing circuitry 810). In some embodiments, the communication element 820 (as with other components discussed herein) can be at least partially implemented as the processing circuitry 810 or otherwise controlled by the processing circuitry 810. In this regard, the communication element 820 can communicate with the processing circuitry 810, for example, through a bus. The communication element 820 can comprise, for example, antennas, transmitters, receivers, transceivers, network interface cards and/or supporting hardware and/or firmware/software and is used for establishing communication with another apparatus. The communication element 820 can be configured to receive and/or transmit any data that can be stored by the memory 840 by using any protocol that can be used for communication between apparatuses. The communication element 820 can additionally or alternatively communicate with the memory 840, the input/output element 830 and/or any other component of the controller 800, for example, through a bus.

In some embodiments, the controller 800 can comprise an input/output element 830. The input/output element 830 can communicate with the processing circuitry 810 to receive instructions input by the user and/or to provide audible, visual, mechanical, or other outputs to the user. Therefore, the input/output element 830 can comprise supporting devices, such as a keyboard, a mouse, a display, a touch screen display, and/or other input/output mechanisms. Alternatively, at least some aspects of the input/output element 830 can be implemented on a device used by the user to communicate with the controller 800. The input/output element 830 can communicate with the memory 840, the communication element 820 and/or any other component, for example, through a bus. One or a plurality of input/output modules and/or other components can be included in the controller 800.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein in connection with the components of circuitry.

As used herein, terms such as “front,” “rear,” “top,” etc. are used for explanatory purposes in the examples provided below to describe the relative positions of certain components or portions of components. As used herein, the term “or” is used in both the alternative and conjunctive sense, unless otherwise indicated. The term “along,” and similarly utilized terms, means near or on, but not necessarily requiring directly on an edge or other referenced location.

The terms “approximately,” “generally,” and “substantially” refer to within manufacturing and/or engineering design tolerances for the corresponding materials and/or elements unless otherwise indicated. The use of such terms is inclusive of and is intended to allow independent claiming of specific values listed. Thus, use of any such aforementioned terms, or similarly interchangeable terms, should not be taken to limit the spirit and scope of embodiments of the present disclosure. As used in the specification and the appended claims, the singular form of “a,” “an,” and “the” include plural references unless otherwise stated. The terms “includes” and/or “including,” when used in the specification, specify the presence of stated feature, elements, and/or components; it does not preclude the presence or addition of one or more other features, steps, operations, elements, components, and/or groups thereof.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

1. A delivery system, comprising:
a mount;
a movement arm rotationally connected to the mount at a first connection point of the movement arm, the movement arm configured to rotate relative to the mount about a first axis of rotation;
a delivery portion; and
a connection arm rotationally connected to the movement arm at a second connection point of the movement arm different than the first connection point, the connection arm configured to rotate relative to the movement arm about a second axis of rotation different than the first axis of rotation, the connection arm configured to support the delivery portion and connect the delivery portion to the movement arm,
wherein the movement arm and the connection arm are each configured to be disposed at least a predetermined minimum height or greater above a ground level at a location of the second axis, and
wherein the predetermined minimum height is greater than a user forefoot clearance height such that the delivery system is configured to allow a user forefoot to be disposed beneath the connection arm and the movement arm at the second axis.

2. The delivery system of claim 1, wherein the delivery portion is configured to rotate relative to the connection arm about a third axis of rotation different than the first axis of rotation and the second axis of rotation.

3. The delivery system of claim 1, wherein the movement arm and the connection arm are each configured to be disposed at least the predetermined minimum height or greater above the ground level at a location of the first axis.

4. The delivery system of claim 1, further comprising a connection plate disposed between the connection arm and the delivery portion, wherein the connection plate is configured to support the delivery portion at an upper side thereof, wherein the connection plate is configured to be supported by the connection arm at a lower side thereof, and wherein the connection plate further defines at least one connector configured to engage a detachable bottle and/or a tool arm.

5. The delivery system of claim 1, wherein a horizontal extent of the movement arm is less than a horizontal extent of the connection arm.

6. The delivery system of claim 1, wherein at least a portion of each of the movement arm, the mount, and the connection arm intersects a common horizontal plane.

7. The delivery system of claim 1, wherein the movement arm and the connection arm are each configured to be disposed a predetermined maximum height or less above a ground level at the location of the second axis, wherein the predetermined maximum height is greater than the predetermined minimum height and less than a user knee clearance height, such that the delivery system is configured to allow a user knee to be disposed above the connection arm and the movement arm at the second axis.

8. The delivery system of claim 7, wherein an entirety of the movement arm is disposed below the user knee clearance height.

9. The delivery system of claim 8, wherein each portion of the movement arm and the connection arm not disposed vertically beneath the delivery portion is disposed below the user knee clearance height.

10. The delivery system of claim 1, wherein the movement arm defines a cavity configured to receive at least a portion of a cable and/or conduit.

11. The delivery system of claim 10, wherein the movement arm is open along a lower side of the cavity such that the portion of the cable and/or the conduit is configured to be inserted into the cavity, and wherein the mount defines an opening configured to receive at least a second portion of the cable and/or the conduit.

12. The delivery system of claim 1, wherein the mount comprises a pivot portion integral with a mounting plate or configured to attach directly or indirectly to a mounting plate, wherein the pivot portion is configured to engage the movement arm and the mounting plate is configured to engage a cabinet or ground.

13. The delivery system of claim 1, wherein the connection arm defines a vertical section at a distal end thereof, and wherein an upper surface of the connection arm is continuously curved in a vertical plane between the second connection point and the vertical section.

14. The delivery system of claim 1, wherein the movement arm and the connection arm are configured to allow the delivery portion to translate horizontally along an axis without rotating relative to the mount.

15. A dental system comprising:
the delivery system of claim 1; and
a storage system comprising at least one cabinet,
wherein the mount is attached to the at least one cabinet or to ground at least partially beneath the at least one cabinet, and
wherein at least a portion of the mount is disposed above a lowermost edge of at least one cabinet door of the cabinet.

16. The dental system of claim 15, the storage system further comprising:
an electrical connection system disposed above the at least one cabinet, the electrical connection system defining a channel therein;
a charging door connected to a second portion of the electrical connection system via a hinge, the charging door configured to rotate about the hinge to allow the charging door to rotate from a closed configuration to an open configuration relative to the second portion of electrical connection system; and
an electrical outlet configured to be disposed behind the charging door in an instance in which the charging door is in the closed configuration,
wherein the electrical outlet configured to be angled at a non-perpendicular and non-parallel angle relative to a surface of the at least one cabinet door of the at least one cabinet in a closed configuration, and
wherein the charging door comprises a slot configured to allow for electrical cables to pass through the slot and behind or into the at least one cabinet in an instance in which the charging door is in the closed configuration.

17. The dental system of claim 15, wherein the electrical connection system is disposed on a countertop above the at least one cabinet.

18. A delivery portion assembly comprising:
a delivery portion; and
a connection plate comprising:
a body with an upper side and a lower side, the body defining:
a tool arm connector;
a detachable bottle connector;
a delivery portion connector at the upper side configured to engage a delivery portion of the delivery system; and
a connection arm connector at the lower side configured to engage a connection arm of the delivery system, wherein the delivery portion is configured to rotate relative to the connection plate.

19. The delivery portion assembly of claim 17, wherein the body of the connection plate further comprises a protrusion on the delivery portion connector or a connector of the delivery portion, and wherein the protrusion is configured to limit rotation of the delivery portion relative to the connection plate.

20. An assembly comprising:
the delivery portion assembly of claim 18;
a mount;
a movement arm rotationally connected to the mount at a first connection point of the movement arm, the movement arm configured to rotate relative to the mount about a first axis of rotation; and
a connection arm rotationally connected to the movement arm at a second connection point of the movement arm different than the first connection point, the connection arm configured to rotate relative to the movement arm about a second axis of rotation different than the first axis of rotation, the connection arm configured to support the delivery portion and connect the delivery portion to the movement arm,
wherein the movement arm and the connection arm are each configured to be disposed at least a predetermined minimum height or greater above a ground level at a location of the second axis, and
wherein the predetermined minimum height is greater than a user forefoot clearance height such that the delivery system is configured to allow a user forefoot to be disposed beneath the connection arm and the movement arm at the second axis.
